(19) United States
(12) Patent Application Publication
(10) Pub. No.: US 2016/0048898 A1
(43) Pub. Date: Feb. 18, 2016

(54) APPARATUS AND METHODS FOR EFFICIENT DELIVERY OF ITEM INFORMATION

(71) Applicant: MOBILETRAC LLC, San Diego, CA (US)

(72) Inventor: JAMES MICHAEL IRISH, San Diego, CA (US)

(21) Appl. No.: 14/825,582

(22) Filed: Aug. 13, 2015

Related U.S. Application Data
(60) Provisional application No. 62/037,572, filed on Aug. 14, 2014.

(51) Int. Cl. G06Q 30/06

(52) U.S. Cl. CPC G06Q 30/0625

(57) ABSTRACT

Apparatus and methods for efficient delivery of a plurality of information regarding vehicles or chattel. In one embodiment, a request for information regarding a quality of plurality of items is received and an item information source is queried for the requested information, which is compiled and provided to the device. At a predetermined future time, second information is received and provided to the device. The second information updates one or more aspects of the requested information. In one variant, the plurality of items are vehicles and the request includes a VIN uniquely associated to each vehicle. The predetermined future time may be monitored an entity which requests the second information, or by an entity which provides it automatically. In another variant, the information source provides the second information in substantially real-time. Consideration may be required in exchange for one or both of the requested information and the second information.

### PRIORITY AND RELATED APPLICATIONS

This application claims priority to U.S. Provisional Patent Application Ser. No. 62/037,572, of the same title, filed on Aug. 14, 2014 and incorporated herein by reference in its entirety.

This application is also related to U.S. Pat. No. 8,725,581 filed on Mar. 13, 2013 and issued on May 13, 2014 and to U.S. patent application Ser. No. 13/159,307 filed on Jun. 13, 2011, which are both entitled “APPARATUS AND METHODS FOR EFFICIENT DELIVERY OF AUCTION ITEM INFORMATION”, each of which are continuations of and which claim priority to U.S. patent application Ser. No. 12/500,513, filed on Jul. 9, 2009 and entitled “APPARATUS AND METHODS FOR EFFICIENT DELIVERY OF AUCTION ITEM INFORMATION”, which claims priority to U.S. Provisional Patent Application Ser. No. 61/134,655, filed on Jul. 10, 2008 and entitled “APPARATUS AND METHODS FOR EFFICIENT DELIVERY OF AUCTION ITEM INFORMATION” and U.S. Provisional Patent Application Ser. No. 61/218,335, filed on Jun. 18, 2009 and entitled “APPARATUS AND METHODS FOR EFFICIENT DELIVERY OF AUCTION ITEM INFORMATION”, each of which are incorporated herein by reference in its entirety.

This application is also related to U.S. patent application Ser. No. 13/007,837 filed on Jan. 17, 2011 and entitled “APPARATUS AND METHODS FOR GENERATION AND UTILIZATION OF SALES LEADS”, which claims priority to U.S. Provisional Patent Application Ser. No. 61/303,209, filed on Feb. 10, 2010 and entitled “APPARATUS AND METHODS FOR GENERATION AND UTILIZATION OF SALES LEADS”, which is also incorporated herein by reference in its entirety. This application is further related to U.S. patent application Ser. No. 13/467,832 filed on May 9, 2012 and entitled “APPARATUS AND METHODS FOR EFFICIENT GENERATION AND DELIVERY OF ITEM INFORMATION”, which is also incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Disclosure

The present disclosure relates in one exemplary aspect to improved methods and apparatus for providing information regarding the history or other aspects of a purchasable item. In one specific embodiment, the present disclosure provides methods and apparatus for delivering information regarding a plurality of vehicles for sale, the information being updated based on real-time entry of changes thereto.

2. Description of Related Technology

Many vehicles, such as automobiles, boats, all terrain vehicles, motorcycles, sports vehicles, etc. come into the possession of auto dealers, financial institutions and/or other businesses and companies (hereinafter referred to collectively as “dealers”) after having, in some cases, at least one previous owner/user. Dealers may come into possession of used vehicles as a result of the vehicle lease agreement ending, as partial payment for a new vehicle (i.e., a trade in), as rental cars or fleet/company vehicles which have been cleared out to make room for newer vehicles, and as repossessed vehicles. Additionally, a private owner may seek to sell a vehicle as well.

Purchase of used vehicles requires research and diligence on the part of the buyer. In many instances, intimate knowledge about various types of motor vehicles would be required to identify a vehicle's potential mechanical problems. Often, there are problems or reasons not to purchase a vehicle that are not immediately obvious to a person merely viewing or test driving a used vehicle. Likewise, a vehicle's market value may not be immediately apparent to even very sophisticated buyers.

Generally dealers are able to determine vehicle history by using the vehicle identification number (VIN number) and one or more accessible vehicle information servers. For example, U.S. Pat. No. 7,113,853 to Hecklinger issued Sep. 26, 2006 and entitled “SYSTEM AND METHOD FOR GENERATING VEHICLE HISTORY INFORMATION” describes a system, method and computer readable storage medium for generating vehicle history information which, based on vehicle history records, determine whether a particular vehicle has a reliability issue and/or has passed import inspection. In addition, market and wholesale values of vehicles may be determined using one or more consolidated vehicle valuation information servers. For example, U.S. Patent Publication No. 20080201163, to Barker, et al., published Aug. 21, 2008 and entitled “VEHICLE-VALUE ANALYZING AND MESSAGING SYSTEMS” discloses a system, process and computer software is disclosed for electronically accessing financial terms related to the acquisition of a vehicle by a purchaser, including contact information, original vehicle information, and the settlement amount.

However, there currently exists no mechanism for supplying information regarding a large number of items/vehicles at once. Moreover, current methods do not provide periodic updates to the information and/or utilize data collected in real-time.

Despite the foregoing systems and methods, there is still a salient need for more efficient and reliable solutions for the delivery of information relating to a purchasable item (e.g., vehicle). Improved techniques and apparatus would ideally be configured to, inter alia, automatically provide periodically updated vehicle information relating to a multitude of vehicles, and to access newly acquired vehicle data in real-time.

### SUMMARY

The present disclosure addresses the foregoing needs by disclosing, inter alia, apparatus and methods for efficient delivery of item information.

In a first aspect, system for providing item information is disclosed. In one embodiment, the system includes (i) an item information source configured to obtain information relating to an item quality for a plurality of purchasable items; (ii) a server entity configured to obtain first information relating to item quality for the plurality of purchasable items, and to obtain second information relating to item quality for the plurality of purchasable items from the item information source; and (iii) at least one client device in communication with the server entity and configured to obtain the first and/or the second information.

In one variant, the server entity is further configured to compare the first and second information to identify one or more relationships of interest (e.g., any differences) existing therebetween; information relating to the identified differences is then provided to the at least one client device.

In another variant, the client process is configured to generate at least a portion of the information relating to the relationships or difference(s) based on being provided the first and second information.

In another variant, the information relating to the item quality for the plurality of purchasable items includes vehicle history information for respective ones of a plurality of vehicles.

In a second aspect, a method for providing information regarding a plurality of items for sale is given. In one embodiment, the method includes: (i) receiving a request for information regarding a plurality of items; (ii) querying an item information source to obtain the requested information, the request configured to trigger a subsequent action at a predetermined future time; (iii) compiling the requested information; (iv) providing the requested information; (v) the subsequent action comprising, at the predetermined future time, receiving second information regarding particular ones of the plurality of items; and (vi) providing the second information. The second information includes, in one variant, a subset of information configured to update one or more aspects of the requested information.

In another variant, the plurality of items comprise a plurality of vehicles and the request for information includes a plurality of vehicle identification numbers uniquely associated to respective ones of the plurality of vehicles.

In yet another variant, the predetermined future time is monitored by a server apparatus configured to, at the predetermined future time, request the second information. Alternatively, the predetermined future time is monitored by an entity for obtaining the requested information, and which is configured to, at the predetermined time, provide the second information absent any request therefor.

In a third aspect, a server apparatus configured to provide information regarding a quality of a plurality of items is disclosed. In one embodiment, the server includes a first interface configured to enable communication with an item information source, a second interface configured to enable communication with a plurality of client devices, a storage apparatus, and a processor configured to run at least one computer application thereon. In one implementation, the computer application is configured to: (i) receive a request for quality information relating to a plurality of uniquely identifiable items; (ii) query the item information source to obtain the requested quality information; (iii) receive the requested quality information; (iv) provide the requested quality information; (v) receive, at periodic intervals, a plurality of second quality information, the second quality information comprising quality information relating to individual ones of the plurality of uniquely identifiable items which has been modified by the item information source in at least one respect; and (vi) provide the second information to at least one of the plurality of client devices.

In one variant, the computer application is further configured to identify the individual modifications represented in the second quality information.

In another variant, the computer application is further configured to request, at the periodic intervals, the plurality of second quality information.

In another variant, the information source is configured to provide the second quality information in substantially real-time as it is inputted by an operator at an input device in communication therewith.

In a fourth aspect, a method is disclosed. In one embodiment, the method includes providing information relating to quality of a plurality of items for sale; and periodically updating the information relating to the quality of the plurality of items for sale upon a determination that one or more aspects thereof have been changed. In one implementation, a predetermined amount of consideration is required in exchange for one or both of the information and the periodic updates. In one variant, the consideration is required periodically substantially simultaneous to a delivery of the updated information.

In a fifth aspect, delivery of updated item information is fully automated in nature. In one embodiment, an application running at an information source or a sever is configured to automatically identify changes to item information via a comparison of newly acquired data to previously stored versions thereof in order to determine which item information has been modified and report the same to the client device(s) which had previously requested item information regarding this particular item.

In a sixth aspect, exemplary methods for delivering item information to a client are disclosed. In one embodiment, the item information is delivered from a server which requests and compiles information from a plurality of sources and condenses and formats the data for delivery to the client. Upon determination of one or more updates to the item information, the server further provides one or more updates to the client. In another embodiment, the item information is presented to a client automatically. In yet another embodiment, the item information is delivered from a stored copy present on a database.

In a seventh aspect, client interface for establishing an account with a server adapted to compile and efficiently deliver item information are described.

In an eighth aspect of the invention, a computer readable apparatus is disclosed. In one embodiment, the apparatus includes storage media adapted to store one or more computer programs which, when executed obtain and deliver information to a client device. In another embodiment, the computer program(s) obtain information from the client device (e.g., via a user interface) and cause transmission of a message to a remote entity such as a data or website server.

These and other aspects shall become apparent when considered in light of the disclosure provided herein.

### BRIEF DESCRIPTION OF THE DRAWINGS

FIG. 1 is a block diagram illustrating an exemplary embodiment of an item information collection (IIC) server of the present disclosure.

FIG. 2 is a block diagram illustrating an exemplary system utilizing the IIC server of FIG. 1 for efficiently delivering item information based on a vehicle identification number (VIN).

FIG. 3 is a block diagram illustrating an exemplary system utilizing the IIC server of FIG. 1 for efficiently delivering item information based on an auction identification (AID) number.

FIG. 4 is a block diagram illustrating an exemplary IIC database for use with the IIC server of FIG. 1.

FIG. 5 is a block diagram illustrating an exemplary system utilizing the IIC server and IIC database of FIGS. 1 and 4, respectively to notify a client of an estimated time when an item will begin auction.

FIG. 6a is a logical flow diagram illustrating an exemplary method of employing the IIC server of FIG. 1 to obtain item information at a client device.

FIG. 6b is a logical flow illustrating an exemplary embodiment of a method of utilizing the IIC server and the IIC database of FIGS. 1 and 4, respectively to efficiently present item information to a client device.

FIG. 6c is a logical flow illustrating an exemplary embodiment of a method of automatically presenting information regarding items for auction.

FIG. 6d is a logical flow illustrating an exemplary embodiment of a method of utilizing previous sales timing information to estimate and alert a client to the beginning of bidding of an item at auction.

FIG. 7 is a block diagram illustrating an exemplary vehicle identification number (VIN) according to the present disclosure.

FIG. 8 is a logical flow diagram illustrating an exemplary embodiment of a method of utilizing a shortened form VIN to obtain information form the IIC server of FIG. 1.

FIG. 9 is a logical flow diagram illustrating an exemplary embodiment of a method of utilizing a verbal reporting embodiment according to the present disclosure.

FIG. 10 is a logical flow diagram illustrating an exemplary embodiment of a method of monitoring an ongoing auction according to the present disclosure.

FIG. 11 is a logical flow diagram illustrating another exemplary embodiment of a method of monitoring an ongoing auction according to the present disclosure.

FIG. 12 is a block diagram illustrating an exemplary network architecture for monitoring and providing updates to item information for use in the present disclosure.

FIG. 13 is a logical flow diagram illustrating an exemplary embodiment of a method of monitoring and providing updates to item information for use in the present disclosure.

© Copyright 2014-2015 KAR Auction Services, Inc. All rights reserved.

### DESCRIPTION

Reference is now made to the drawings listed above, wherein like numerals refer to like parts throughout.

As used herein, the term “application” refers generally and without limitation to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java Xlet™ that runs within the JavaTV™ environment.

As used herein, the terms “client device,” “terminal,” “personal electronic device” (PED) and “user device” include, but are not limited to, personal computers (PCs), whether desktop, laptop, or otherwise, personal digital assistants (PDAs) such as the “Palm®” family of devices, cellular or “smart” phones, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), or alternatively via wireless mechanisms and protocols such as 3GPP/3GPP2, Bluetooth™, IrDA interface, IEEE Std. 802.11, UWB (e.g., IEEE-Std. 802.15 or similar), ZigBee, WiMAX (802.16), Wireless Application Protocol (WAP), GPRS, GSM, LTE/LTE-A, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally and without limitation to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, OLEDs, and fluorescent devices.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS/LTE/LTE-A, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “service provider” refers generally to services provided remotely to the user including, for example, data streaming, data analysis, financial account management and trading, data archiving and storage, Internet access, content delivery, telecommunications, etc.

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the present disclosure.

As used herein, the term “vehicle” refers to any form of air, land or water transportation for either person, animals, and/or inanimate objects including, without limitation, buses, cars, sports utility vehicles, all-terrain vehicles, motorcycles, boats, drones, robotically controlled vehicles, etc.

### Description of Exemplary Embodiments

It is noted that while the system and methods of the present disclosure are described with respect to delivery of information regarding vehicles, certain aspects of the disclosure may be useful in other applications, including, without limitation, other types of items or chattel.

Moreover, while described primarily with respect to sale of one or more items, it will be appreciated that the present disclosure is in no way so limited; for instance, any sort of “transaction” (whether single or multi-part, for consideration, no consideration, as a promotion, gratuity, or otherwise) can be utilized in conjunction with the various aspects of the present disclosure.

### Item Information Collection (IIC) System

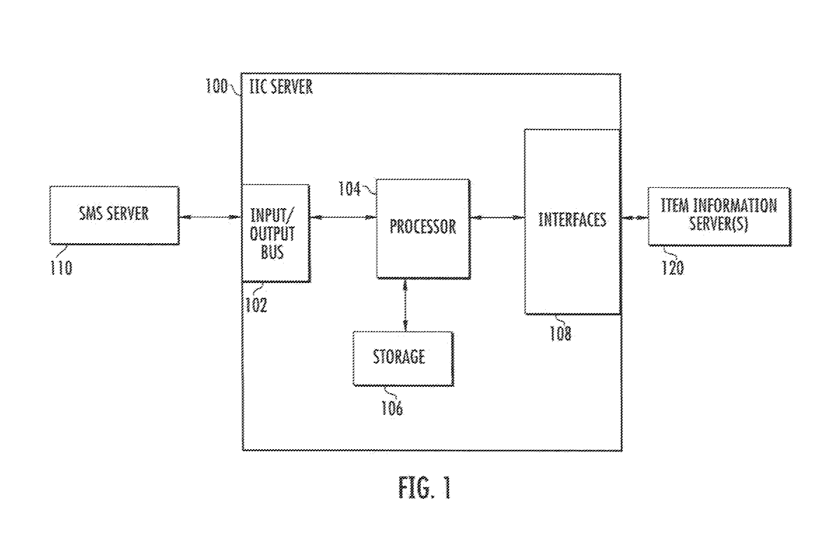

One salient feature of the present disclosure is the utilization of one or more Item Information Collection (IIC) servers. An exemplary IIC server 100 is illustrated in FIG. 1. As shown, the IIC server 100 generally comprises an input/output bus 102, a storage device 106, a digital processor 104 and a plurality of interfaces 108 for connection to other devices (not shown) via one or more networks.

The input/output bus 102 of the IIC server 100 is the subsystem for the transfer of data into and out of the IIC server 100. For example, data in the form of a request may be transferred into the server 100 from client devices via a short message service (SMS) server 110; and item information may be transferred out of the server 100 to the SMS server 110 and on to associated client devices.

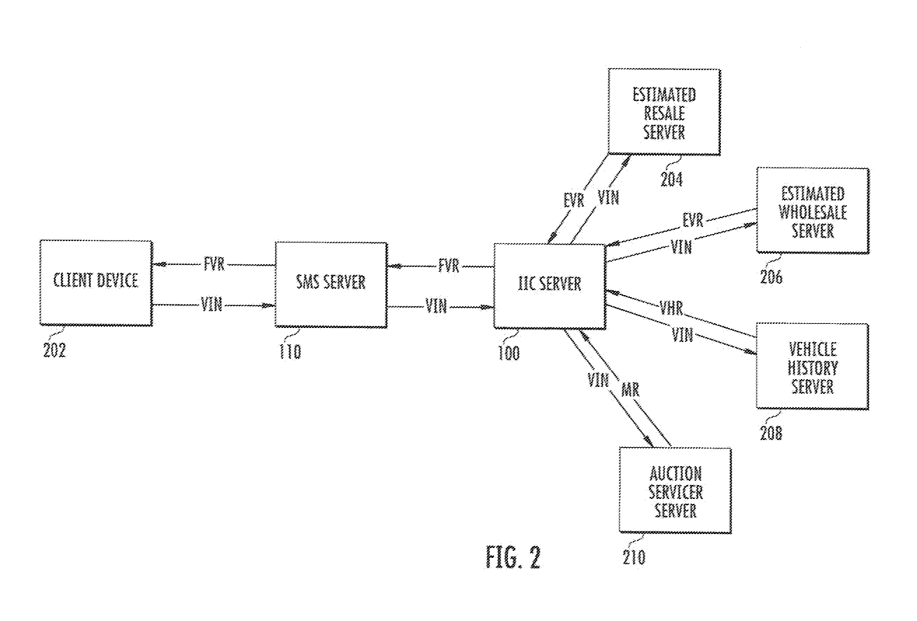

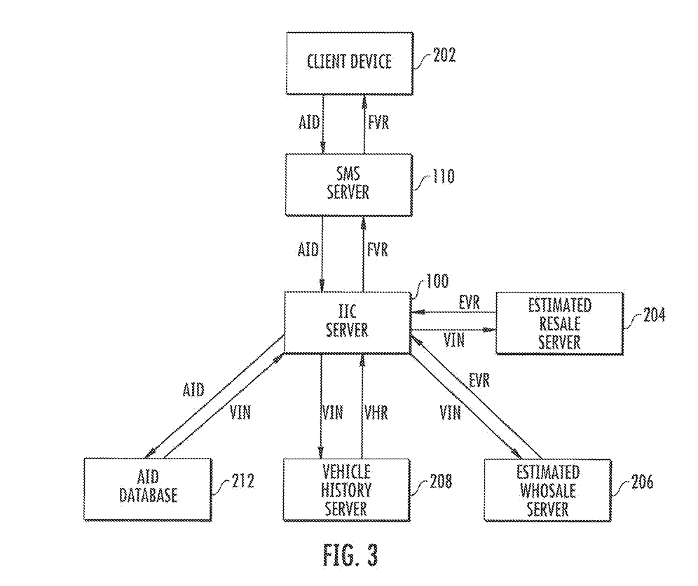

The storage device 106 of the IIC server 100 is adapted to store processed and formatted item information. In one embodiment, the items may comprise vehicles and the processed and formatted item information may be stored by vehicle VIN number (see e.g., the VIN embodiment discussed below with respect to FIG. 2). In another embodiment, items are referenced by auction identification number (AID), which will be discussed in greater detail below (see e.g., the AID embodiment discussed below with respect to FIG. 3), the AID may be cross-referenced to VINs in vehicle auctions.

As illustrated, the IIC server 100 further comprises a digital processor 104, which, in one embodiment, houses computer programs configured to cause the server to generate requests to various item information servers 120 as well as format data received from the item information servers 120 into data which is more efficiently transmitted and more easily read by the client devices associated with the SMS server 110. Other functions of the digital processor 104 will be discussed in detail below as well. Exemplary item information servers 120 include, inter alia, estimated resale servers, estimated wholesale servers, AID database, auction servicer servers and/or vehicle history servers for situations involving the auction of vehicles. Formatting may, in one embodiment, comprise summarizing and/or presenting only portions of the data received so as to generate a message which is most germane or suitable (i.e., simple or small enough) for transmission to a client via text or other messaging in a timely and reliable manner.

It is also appreciated that the methods of the present disclosure may be practiced using any configuration or combination of hardware, firmware, and/or software, and the various components and/or logical processes may be disposed within one or any number of different physical or logical entities. Myriad different configurations for practicing the concepts of the present disclosure will be recognized by those of ordinary skill in the network arts provided the present disclosure.

The IIC server 100 can also be masked or controlled by a “business rules engine” or other logical wrapper or layer as described subsequently herein.

### Item Information Collection Using Vehicle Identification Number (VIN)

In one embodiment of the present disclosure, the IIC server 100 services vehicle auctions. In another embodiment, customers may obtain information regarding vehicles in private sales. The vehicles are thus associated with unique VIN numbers which are input from a client in order to return vehicle information, as illustrated in FIG. 2. Although illustrated and described in terms of SMS-based text messaging, it will be appreciated that communication to and from the client device may occur via any number of mechanisms including, inter alia, web-based instant messaging.

As shown, in FIG. 2, at a client device 202, the client enters the vehicle VIN number (such as via a camera function or manual entry thereof). The VIN is then sent to an SMS server 110 which forwards the message to the IIC server 100. In another embodiment, the VIN is sent directly to the IIC server 100 via a web-based communication thereto. At the IIC server, the VIN number is used in a request message which is sent to any number of item information servers 120. In the exemplary embodiment of FIG. 2, the IIC server 100 may request information from an estimated resale server 204, an estimated wholesale server 206, a vehicle history server 208 and/or an auction servicer server 210; however alternate servers adapted to transmit information regarding used items may also be used consistent with the present disclosure.

The estimated resale 204 and wholesale 206 servers, upon IIC server 100 request will provide estimated value reports (EVR) to the IIC server 100. The EVR of the estimated resale server 204 includes an estimate of the amount a client may expect to be able to resale the vehicle for. The EVR of the estimated wholesale server 206 includes an estimate of the amount a client may expect to pay wholesale for the vehicle.

The vehicle history server 208 uses the vehicle VIN to retrieve a vehicle history report (VHR). In one embodiment, the vehicle history server 208 may be configured to return history reports generated by, inter alia, a department of motor vehicles, Autocheck™, CarFax®, or generated by any number of web-based servers such as, inter alia, isitalemon.com, eztitlesearch.com, ebay.com, cardectective.com, Gov-Reports.com, etc.

The auction servicer server 210 is a server associated with an online auction site which provides other market information to the IIC server 100 in the form of a market report (MR) including inter alia a crossreferenceable auction identification number (AID) to vehicle identification number (VIN) table. In one embodiment, the auction service server 210 may comprise an auction servicer such as the well-known Manheim, Adesa and many others. Manheim provides the vehicle dealers with a marketplace in which they can acquire vehicles, research vehicles in advance and inspect them in person before bidding. In addition auction companies provide certification of current state of the vehicle.

The IIC server 100 is adapted to receive and compile any reports received from the various item information servers 120 (including, inter alia, EVR, VHR, and/or MR). Computer applications located on the processor 104 of the server 100 direct the formatting of the reported information into a form that is suitable for transmission via SMS message (e.g., text message), termed a formatted item report (FIR). In one embodiment, the FIR is duplicated and one copy is sent for storage at an IIC database (not shown), which will be discussed in greater detail below.

The FIR is then sent to the client device 202 via the SMS server 110 according to standard SMS message protocol. This approach (use of extant SMS servers and protocol) advantageously obviates the need for additional adaptation or modification of the existing cellular or wireless infrastructure, although it will be appreciated that other bearer transports and protocols may be used consistent with the disclosure.

In another embodiment, the client may, rather than inputting the vehicle VIN number, instead use a camera function of the client device 202 to take a picture of the VIN number, or OCR software and a scanner. The client device 202 will then utilize the optical character recognition program (such as GOCR, JOCR, etc.) to convert the pictured image to text, the text is then sent to the SMS server 110 and/or directly to the IIC server 100 as discussed above. The VIN may also be represented by one or more bar codes, which might be distributed to users before the auction.

It is appreciated that other forms of VIN entry may also be utilized including e.g., speaking or saying the number into a client device capable of recognizing and translating the speech to text. For instance, a speech recognition algorithm may be resident within the program memory of the device, and in conjunction with a microphone, convert received analog signals from a user (e.g., a VIN or AID) into a digital representation thereof, which is then used to populate an appropriate FIR. Such speech recognition algorithms and systems are well known in the art, and accordingly not described further herein. In yet another embodiment, the speech recognition system may be implemented at the IIC server 100 or other entity of the herein described disclosure.

### Item Information Collection Using Auction Identification Number (AID)

In yet another embodiment, the IIC server 100 of the present disclosure utilizes an AID number which is input from a client in order to return item information, as illustrated in FIG. 3. Although FIG. 3 demonstrates sending and receiving data to a client device via SMS-based text messaging, it will be appreciated that such communication may occur via any number of mechanisms including, inter alia, web-based instant messaging.

Modern VIN numbers are 17 character alpha-numeric serial numbers used to particularly identify an item. These are often printed on the vehicle, however, in a fast-paced auction situation, they may be hard to read and quickly enter into a client device in order to gain access to information relating thereto. Accordingly, the present embodiment of the disclosure utilizes an AID, which are auction-specific identification numbers comprised of a lane number (two digit number), followed by a hyphen, and a space number (three digit number). The AID is indicative of when and where the vehicle will be run. In a vehicle auction situation, the AID is significantly smaller and is made much more visible to the bidders than a VIN number and may be entered at a client device much more quickly, thus providing access to information regarding a vehicle more quickly. Likewise, a client entering an AID (five digits) is less likely to make an error than a client entering a VIN number (17 digits). In auctions involving other items (e.g., not vehicles or items having VIN numbers), utilization of an AID helps assist clients in specifically identifying an item.

If used in a vehicle auction, the AID are determined and cross-referenced to vehicle VIN by an auction-operated AID database 212 prior to an auction. In other words, the auction representatives, prior to an auction will enter AID and their corresponding VIN into an AID database. As illustrated in FIG. 3, a client then need only input the AID at a client device 202 in order to quickly and easily receive information regarding particular vehicles.

Specifically, as FIG. 3 illustrates, clients enter one or more AID at client devices 202, which then forward the AID containing message to the IIC server 100 via the SMS server 110. The IIC server 100 then sends a request containing the AID to the AID database 212 for translation into a VIN number. The VIN number is then sent in a request to various item information servers 120, including, inter alia, an estimated resale server 204, an estimated wholesale server 206, and/or an estimated vehicle history server 208. These entities may also be integrated into one unified server, or any combinations thereof. The item information servers 120 return to the IIC server 100 EVR, VHR and/or other item reports.

As in the embodiment of FIG. 2, the IIC server 100 retrieves information from the received reports and formats a FIR. In one embodiment, two FIR are generated; one is pushed for storage at a IIC database (not shown) and the other is sent to the client device 202 via the SMS server 110.

### Error Checking Functions

The various embodiments of the disclosure described herein may also be configured with an ambiguity resolution system or algorithm. For example, suppose a user enters an AID or VIN which is one digit off from the actual number. This could cause the system to return an erroneous report (or none at all), thereby wasting precious time for the user. Accordingly, several mechanisms can be used to mitigate this circumstance. In one variant, a local client checker algorithm is used to match a client-entered number (whether via graphical UI, speech, scanner, or otherwise) with a prestored list of VINs or AIDs for that day (obtained from the auction manager). Simply stated, if the entered number does not match anything up for auction that day, an error message will be immediately generated, and optionally the defective (non-matching) portion of the number highlighted on the display.

In another variant, a “back end” checking system can be used, wherein the same function as that previously described for the client is performed on one or more back-end servers.

In more sophisticated embodiments, the error checking functions comprise the user entering one or more additional pieces of information about the vehicle so that the entered VIN or AID can be cross-referenced. For instance, along with the VIN/AID, the user might also enter or say “Aston Martin” (referring to the mfgr.) and “black” (referring to the vehicle's color). The back-end server can then also match these elements (which may be coded by numbers, letters, etc. which are derived from the user's “plain language” input) to those stored with the VIN for the vehicle, in effect cross-checking the VIN and additional data to be sure that all match up. If, for example, the VIN entered by the user is one digit off, it may return a different color vehicle, which would indicate an error in the VIN somewhere. If the AID were one digit off, it may return a vehicle of a totally different make and perhaps color. In this way, the user will not be inadvertently “spoofed” by receiving a message from the server with information that ostensibly appears to be relevant, but in fact actually relates to a totally different vehicle. It may take the user an appreciable amount of time to recognize this error, delete the data, and re-enter and receive the correct data, which may also be too late to place a bid.

### Item Information Collection (IIC) Database

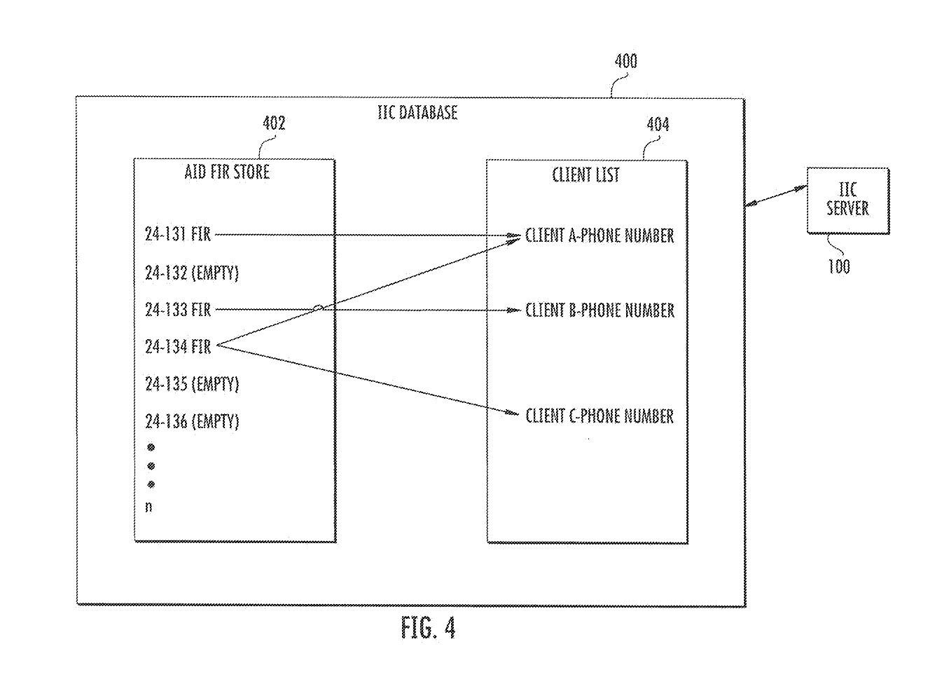

An exemplary IIC database 400 is illustrated in FIG. 4. In the illustrated embodiment, the IIC database 400 generates a list of AID numbers and stores FIR under the AID as these are generated in an AID FIR store 402. As clients request information for one or more of the items based on AID numbers, the database creates a client list 404. The client list 404 lists clients by name (e.g., “Client A”, “Client B”, “Client C”), telephone number and/or account number and cross references the clients to the AID numbers of the items they have expressed interest in and/or received information about.

It is also appreciated that, in another embodiment (not shown), the IIC database 400 may collect and cross reference according to VIN numbers rather than AID numbers. The IIC database 400 is thus in data communication with the IIC server 100 and in one embodiment, one or more of the functions discussed herein are the result of one or more applications running on the processor 104 of the IIC server 100

As illustrated in FIG. 4, the AID FIR store 402 first creates a list of all AID for each of the items at a particular auction the AID entries will be empty when the store 402 is created. Then, a client requests information about the item by sending to the IIC server 100 the item AID in a text message (see also VIN embodiments above). As discussed above, the IIC server 100 will take appropriate action to retrieve information and format the information into an FIR. One copy of the FIR is sent to the client via return text message, and the other copy is pushed to the IIC database 400 for storage in the AID FIR store 402 according to the AID which it relates. The IIC database 400 also creates an entry in the client list 404 for the particular client requesting the information and links the AID FIR entry to the client entry to be used for billing and/or other purposes.

For example, suppose Client A requests information about items 24-131 and 24-134. When generated, the FIR will be placed in the AID FIR store 402 for each of the AID and linked to a client entry for Client A. Then, when Client B requests information about item 24-133, the database 400 will search the AID FIR store 402 to determine whether an FIR has previously been generated. The database 400 “knows” if one has been generated by determining whether the entry is empty or not. In the case of item 24-133, Client A had not previously requested information regarding that item. Thus, the entry is empty and the IIC server 100 will be triggered to begin generating an FIR (as discussed above), once completed one copy will be stored in the AID FIR store 402 and Client B will be entered into the client list and linked to the AID FIR store 402 entry. Client C then requests information about item 24-134 (which was previously requested by Client A). The database 400 determines that the entry contains the FIR and thus copies it and forwards the copy to Client C, while also linking Client C to the AID FIR 402 entry.

### Automatic FIR Delivery

In yet another embodiment, the present disclosure is fully automated in nature. According to this embodiment, the client is not required to enter any information regarding items of interest upfront. Rather, an application running on the client device is configured to utilize information regarding the most recent item sold at the auction to determine which item is next to be auctioned. The interactive application then prompts the client for whether the client is interested in receiving the FIR for the item. If the client discloses an interest, then, as described above, the IIC server 100 will request information from various item information servers 120 and generate an FIR therefrom. As noted above, in one embodiment, the server 100 may also create a duplicate FIR for storage at an AID database 400 (or other similar database utilizing VIN rather than AID).

For example, suppose that a client activates the interactive application running on the client device while the lineup of items at an auction is as given below:

Item 225: BMW 330

Item 226: BMW 650

Item 227: BMW 545

The application will retrieve information from the IIC server 100 which is in data communication, via a live feed, to an auction-operated server or some other server or database that is updated as items are bought and sold at the auction. The retrieved information will enable the application to determine which item in the lineup was the last to be bought/sold, and/or which is currently being bid upon. Because vehicle auctions in particular proceed very rapidly, the application in that context will automatically default to the next available item. Thus, if the application were activated while Item 225 was on the auction block, the application would automatically default to Item 226, which is the first item the client may reasonably seek information about and/or expect to place a bid on. This avoids the system “lagging” real time. The application thus prompts the client concerning the client's interest in information regarding that item (specifically information in the form of a FIR compiled from, inter alia, EVR, VHR and MR). If the client responds affirmatively (indicating a desire to view the information regarding Item 226), the application requests the information and receives a text message FIR which is displayed to the client. Accordingly, the client is able to get information on the items as they come across the auction block, without having to enter a VIN (or taking a picture or scan thereof) or an AID.

### Reminders/Alerts and Time Estimates

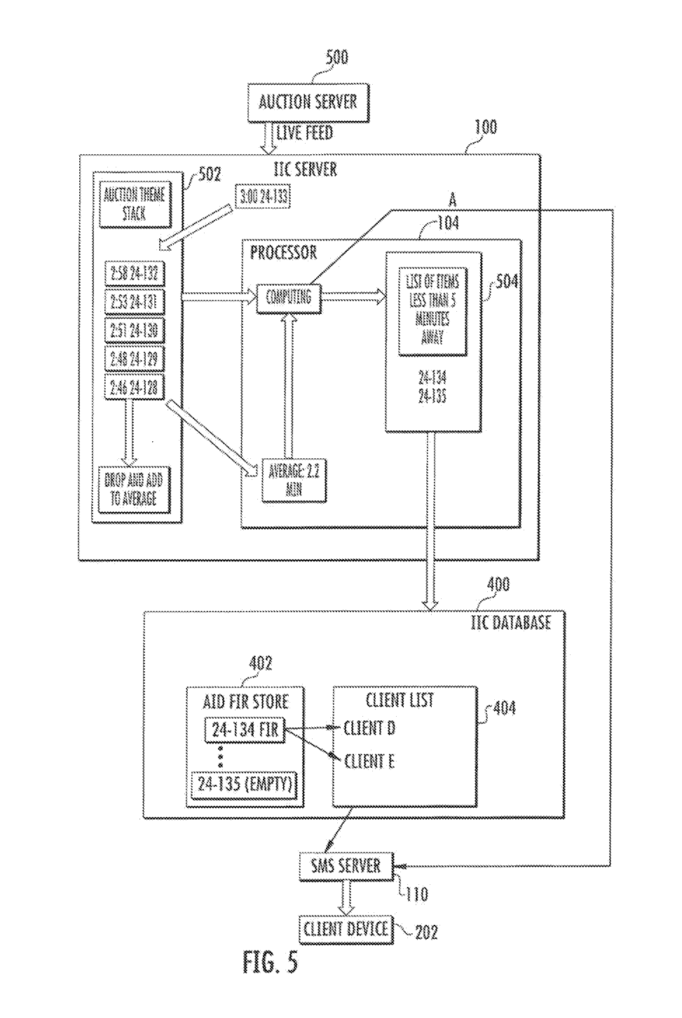

Referring now to FIG. 5, an embodiment is described wherein the IIC server 100 is configured to communicate with the client device when previously selected items are estimated to be soon passing the auction block (i.e., when bidding is soon to begin on the item), and/or to alert or remind the client of this fact. Although illustrated and described in terms of SMS-based text messaging, it will be appreciated that communication may occur via any number of mechanisms including, inter alia, web-based instant messaging or WAP (wireless application protocol) or the like.

The IIC server 100 may communicate estimates, reminders and/or alerts in various situations. For example a reminder/alert may be sent upon client selection to be reminded/alerted, e.g., at the time of viewing a received FIR at the client device, the client selects to be reminded/alerted when this item is soon to come on the auction block (e.g., five minutes in advance). Also, estimates may be sent upon client request for a time estimate for a specific item, e.g., by sending an SMS message to the IIC server 100 stating the command “time” or “time estimate” or the like, and the AID or VIN used to identify the item. It is also appreciated that the client may select a time prior to the beginning of bidding to receive reminders/alerts and/or that the client may choose to receive a reminder/alert even after having been given a time estimate.

As illustrated in FIG. 5, the IIC server 100 is adapted to receive a live feed from an auction-operated server 500 (or other server providing updated information regarding the sale of items at the auction). The auction server 500 gives constant updates as to the time each item for auction is sold. This information is added to an auction time stack 502 in the server 100. The auction time stack 502 is averaged after each new sale time addition and the averaged information is used to compute a dynamic list 504 of items which are estimated to be less than a set number of minutes away. In the exemplary embodiment the processor 104 uses 5 minutes, however longer or shorter periods may be utilized consistent with the present disclosure, and may in fact be varied as a function of the then-prevailing situation or dynamics of the auction (e.g., two minutes for anything in Lane 2, five minutes for anything in Lane 4, etc.).

The information held in the dynamic list 504 is then compared (by AID or VIN number) it the AID FIR list 402 of the IIC database 400, in order to determine if any clients have shown interest in the items whose auctions will begin shortly. The dynamic list 504 may also be compared to other database 400 lists (not shown) including lists for those clients who have specifically requested a reminder/alert regarding particular items.

As illustrated in FIG. 5, Client D is linked to items 24-134, and Client E is also linked to item 24-134. Thus, since item 24-134 is in the list of items less than 5 minutes away, the IIC server 100 sends an alert or reminder text (or other) message via the SMS server 110 to the client devices 202 of Clients D and E indicating that bidding is soon to begin for that item.

In a situation where a client has requested a time estimate, via pathway A, the processor 104 computes, based in part on the averages determined from the auction time stack 502, when bidding on that particular item should begin and reports that to the client device 202 via the SMS server 110.

The mechanism described in FIG. 5 may also be used, to enable a client to request the current item (by AID) being bid on in all lanes using a command which states, “AID”, “current AIDs” or the like.

### Inspection Information

In another embodiment, the IIC server 100 may also access an inspection information server (not shown) giving item condition information such as, inter alia, whether there are/is scratches, dents, frame damage, etc. to a vehicle. Providing such information obviates the client having to access the vehicle's appearance from a mere glance and without significant inspection. Rather, the auction operators and/or a third party will view the auction vehicles appearances and actual physical characteristics in detail and report relevant information to a database listed by VIN or AID which is accessed by the IIC server 100 in much the same manner as the other item information servers 120 discussed above. Note that this inspection information may be different than or not contained in a CarFax or similar third-party report, the latter which may describe only if the car has had any major accidents (e.g., those reported to police or DMV), hail damage, flooding, etc., but not necessarily more minor every-day type current damage such as door dings, scratches, faded paint or interior, etc.

### Warranty Information

The systems and methods of the present disclosure may be further utilized in conjunction with one or more entities adapted to report the status of a warranty (or provide other warranty-related information) for one or more automobiles. For example, the warranty reporting entities may disclose that an automobile is still under a factory or third-party (aftermarket) warranty, remaining time and/or mileage on that warranty (as many auto warranties are structured as “lesser of X years or Y miles”), and/or whether an existing warranty may be extended. This information, similar to the information disclosed above, may be sent to a client device via email, text message/SMS, and/or voice message.

In one embodiment, the user is also provided with data indicating the level of warranty service actually performed on the vehicle (if available). For example, a history of multiple non-routine service calls on a car may be indicative of a “lemon” or one which has undergone significant mistreatment or damage. In one variant, the aforementioned SMS/text provided to the user has a multi-digit code which indicates (i) the number of services at a factory authorized service center; and (ii) the type of each service (e.g., “R” for routine or preventive maintenance, and “O” for other). A car with multiple “O's” may therefore indicate a problem vehicle.

In another embodiment, the user may further be given an opportunity to purchase an extended warranty or related (e.g., complementary) coverage, if available. The purchase may be routed through a separate server associated with a warranty vendor or multiple vendors, or routed through the service described above and then to a third party vendor. These vendors utilize information about the vehicle and the user to generate an extended warranty contract which is forwarded to the user (via email, regular mail, or other mode). For example, a warranty vendor may obtain information about the vehicle by utilizing the VIN and/or may gain information from the vehicle manufacturer. This information is then forwarded to a call center which completes a warranty contract, or may generate an email to be sent to the registered email address associated with the user.

### Methodology

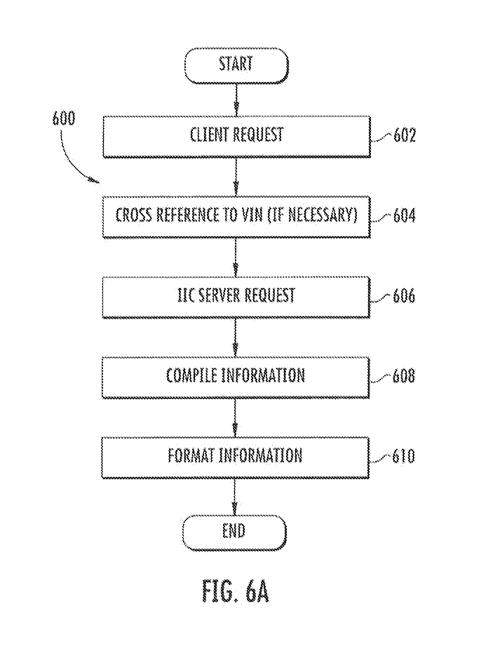

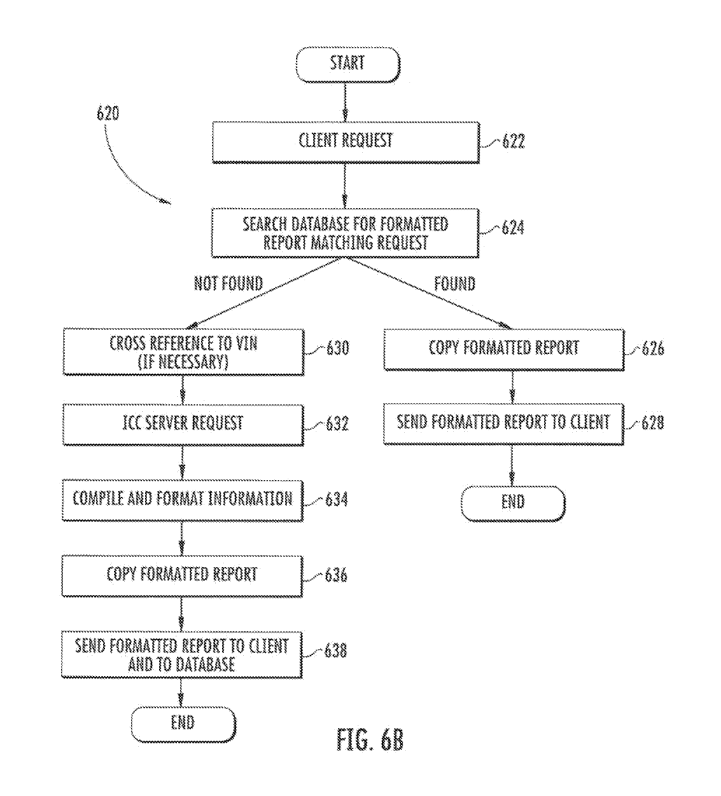

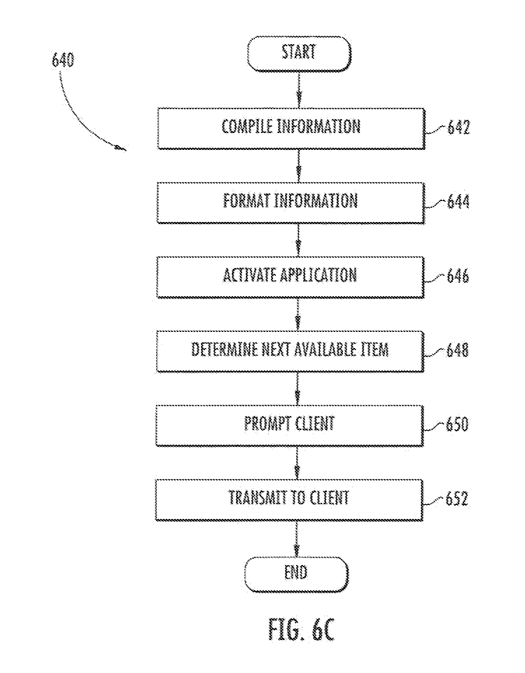

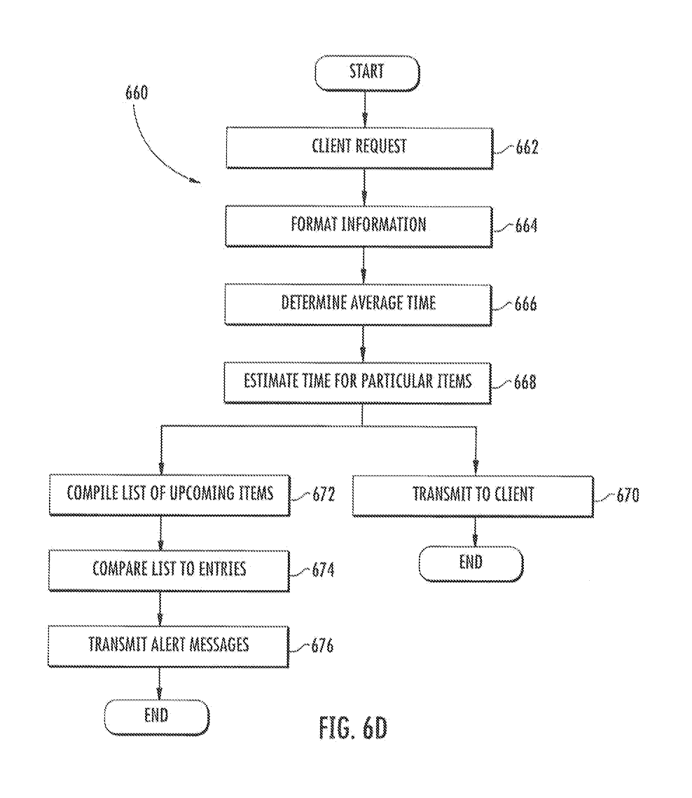

An exemplary method 600 of employing the IIC server 100 of the present disclosure to obtain item information at a client device is now described with respect to FIG. 6a. As illustrated, at step 602, the client sends distinguishing information about the item(s) the client is interested in obtaining information about, such as the vehicle VIN or a picture of the VIN, the AID, or the item number to the IIC server 100. In one embodiment, the distinguishing information (VIN, AID or the like) is sent from the client device 202 to the IIC server 100 via an SMS server 110. Then, per step 604, if the distinguishing information is an AID or item number, it is cross-referenced to a VIN number. In one embodiment this is accomplished via connection to an AID database 212. Then, per step 606, a request is sent from the IIC server 100 to various item information servers 120, including for example, an estimated resale server 204, an estimated wholesale server 206, an vehicle history server 208, an inspection information server and/or auction servicer server 210. Per step 608, information received from the item information servers 120 is then compiled and formatted into an FIR suitable for transmission to the client in a reply message (step 610).

An exemplary method 620 of utilizing and updating an IIC database 400 for the presentation of item information to a client device is given in FIG. 6b. The method 620 comprises at step 622 the client requesting information about a particular item. The request is, in one embodiment, accomplished by the client sending the AID or VIN (or other distinguishing information) to the IIC server 100 via an SMS server 110. Per step 624, the IIC server 100 searches the IIC database 400 for a FIR relating to the AID or VIN submitted. If a FIR is found, then, per step 626, it is copied; and, per step, 628 sent to the client. Alternatively, if no FIR relating to the AID or VIN submitted is found, the IIC server 100 cross-references the AID to a VIN number, if necessary (step 630) and then uses the VIN number to request information from the various item information servers 120 (step 632). The received information is then compiled and formatted into an FIR (step 634). At step 636, the FIR is copied and at step 638, one copy is transmitted to the client in a reply message and one copy is pushed to the database 400.

An exemplary method 640 of automatically presenting information regarding items for auction is given in FIG. 6c. As illustrated, at step 642, the method 640 comprises compiling information regarding each of a plurality of items for auction, then per step 644, the information is formatted into a format which may be easily and quickly transmitted to a client device (e.g., a text message or instant message). At step 646, the client activates the application on the client device. Then, at step 648, the next available item up for bid is determined. At step 650, the client is prompted to indicate whether the client would like information relating to the next item for bid. If the client does indicate a desire for such information, then at step 652, the information is transmitted to the client.

FIG. 6d illustrates an exemplary method 660 for utilizing previous sales timing information to estimate and alert a client to the beginning of bidding of an item at auction. As shown, the method 660 comprises at step 662 requesting information about a particular item. This is, in one embodiment, accomplished by the client sending the AID or VIN (or other distinguishing information) to the IIC server 100 via an SMS server 110. Per step 664, an entry is created indicating the client's interest in the particular item and/or an interest in receiving an alert and/or an interest in receiving an estimate as to when the item will come up for auction. Per step 666, an average time per item is determined given data regarding the time required to sell previous items. Using the average time required, the time for the particular item of interest is estimated (at step 668). The estimated time may be sent to the client, at step 670. Alternatively, average time may be used to compile a list of items which are within a certain time range of being available for auction (step 672), and at step 674, list of items within a certain time range is compared to a list of entries representing clients who have expressed interest in one or more items. At step 676, alert messages regarding the items which will come up for auction within the time range of interest are sent to the appropriate clients.

### Item Information Collection Using Shortened Form Vehicle Identification Number (VIN)

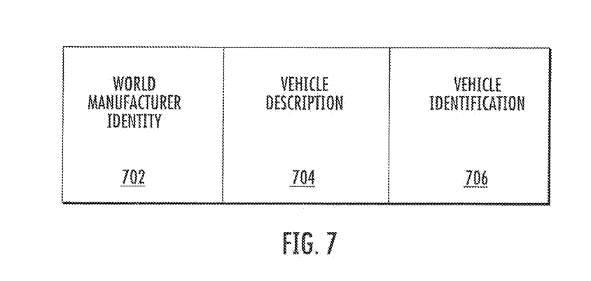

A world-wide standard established by the International Organization for Standardization (ISO) for VIN systems has been implemented in many countries. As illustrated in FIG. 7, according to the standard, the VIN comprises three sections; the first section describes the world manufacturer identity 702, the second describes the vehicle 704, and the third identifies the vehicle 706. The last 6-8 digits of the vehicle identification section 706 generally are standardized to indicate a serial number and assembly line where a particular vehicle was manufactured, the number the vehicle was off the line, and the plant which manufactured the vehicle. Thus, the final few digits of a vehicle's VIN in many instances comprise a series of numbers which are completely unique to that particular vehicle.

Accordingly, in another embodiment of the present disclosure, rather than using a full seventeen (17) digit VIN, a shortened form of the VIN (the final 6-8 digits) may be provided to the IIC server 100 to receive information about the vehicle. In other words, a user, in one embodiment, may simply transmit the last 6-8 digits of a VIN via SMS text or web-based message to the server 100 of FIG. 2. The user will then be returned the FIR corresponding to the vehicle in question.

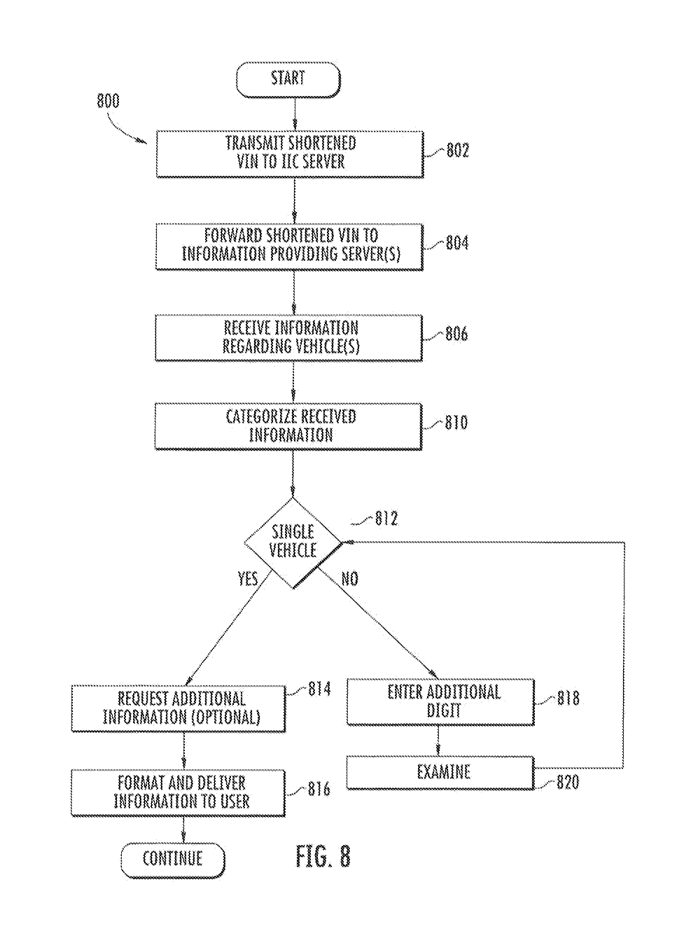

As noted previously, the final 6-8 digits of a VIN are often unique to a particular vehicle. However, in certain cases the final 6-8 digits of a VIN will produce ambiguous results, i.e., may not be unique to a single vehicle but instead may be identical for two or more vehicles. In order to determine whether the submission of the final 6-8 digits of a VIN to the IIC server 100 will produce ambiguous results, a computer program may be run on the IIC server and perform the methods disclosed herein with respect to FIG. 8.

Per step 802 of the method 800, the computer program prompts the user to enter only the final 6-8 digits; the shortened VIN is then transmitted to the IIC server 100. The IIC server 100 then, per step 804, sends the shortened VIN to one or all of the information providing servers 204, 206, 208, 210. At step 806, the IIC server 100 receives from the information providing server(s) 204, 206, 208, 210 information regarding the one or more vehicles having the shortened VIN. For example, if the IIC server 100 merely sends the information to e.g., the vehicle history server 208, the server will return information regarding every automobile having sharing the shortened VIN. Alternatively, the IIC server 100 may send the information to more than one information server and receive back a plurality of information which relates to one or more vehicles.

Per step 808, the computer program running on the IIC server 100 examines the information received from the server(s), such as EVR, VHR, and/or MR and organizes the results into one or more categorizes based on the complete VIN. If results regard a single vehicle, then the organization will produce a single category at step 810. If the information regards a single vehicle only, the computer program may then proceed at step 812 to request additional information form any remaining information providing servers using the VIN (if necessary). Per step 814, the information is then formatted and delivered (in the form of an FIR) to the user.

At step 810, the categorization of the received information results in two or more categories, i.e., two or more vehicles share the shortened VIN, computer program may be configured to prompt the user for entry of an additional digit (step 816). In other words, the user may be prompted to enter the digit of the VIN which immediately precedes the entered 6-8 digits. At step 818, the computer program utilizes the additional digit to examine the various vehicles sharing the shortened VIN. If the provided digit enables the computer program to narrow the pool of vehicles to just one vehicle (step 812), then the method repeats at step 814. If it still cannot be determined which vehicle a user is requesting information about, the program may continue to prompt the user for more digits (step 816).

For example, suppose the full VIN of a particular vehicle which a user would like information about is 2HNYD28358H537353 and that the user is prompted to enter the last 7 digits of the VIN (H537353) as the shortened VIN. The shortened VIN is then transmitted to the IIC server 100 which subsequently transmits the shortened VIN to the vehicle history server 208 for a search based thereon. In this example suppose the vehicle history server 208 returns three VHRs based on the shortened VIN to the IIC server 100 for the following three vehicles:

Vehicle #1—2HNYD28358H537353;

Vehicle #2—2PKLM25084H537353; and

Vehicle #3—2PTSM54183H537353.

The IIC server 100 then categorizes the received reports based on the full VIN. Thus, three categories are created, the first category for the VIN 2HNYD28358H537353 having the VHR for that VIN placed therein, and so forth. If the IIC server 100 had queried other servers 204, 206, 210 (as well as the vehicle history server 208), the additional reports and information received therefrom would also be categorized into one of the above three categories based on the full VIN as indicated above. For example, EVR received from an estimated resale server 204 and/or a wholesale server 206 for each of the three vehicles are also placed into a category according to the full VIN. Because three VHRs were received, the computer program running on the IIC server 100 will next prompt the user to enter another digit of the VIN for the vehicle he/she is attempting to gain information about. In the presented example, the digit just before the previously entered 7 digits (of the shortened VIN) for the vehicle in question is 8, thus the user would enter an 8 when prompted. The IIC server 100, upon receiving the entry would compare the entered digit to the tenth digit of each of the full VINs. In the present example, the computer program determines that the user is not requesting information about Vehicle #2 or Vehicle #3, as the VINs do not match; thus it no longer needs the information stored with respect to these vehicles. Next, the IIC server 100 formats and sends all of the information stored in the first category (i.e., category relating to the first vehicle) to the user. If information has not been requested from the remaining information providing servers 204, 206, 210, the IIC server 100 may also request information therefrom using either the shortened or full VIN, formats, and transmits the information to the user as discussed above.

In yet another embodiment, an alpha, numeric or alpha numeric descriptor of 6-8 characters may serve the same purpose as the shortened VIN discussed above (the final 6-8 digits of the VIN). For example, descriptor “BMW7654” may be utilized. The foregoing example utilizes the vehicle make/model which provides the equivalent amount of information as additional digits of the VIN and is much easier for users to enter then a complex string such as a VIN.

### Portable Vehicle Information System

One salient advantage of the methods and apparatus disclosed above regarding provision of a system which enables a user to enter a VIN (or shortened form thereof) for obtaining information about a vehicle regards the ability of the system to communicate information to the user efficiently, and without the requirement of having internet access. In other words, a user need not rely on the seller's report of vehicle history and value, but rather, enables the user to verify this information him/herself no matter where the user is. The aforementioned IIC server 100 provides a user with a portable substitute for looking up and receiving auto history and estimated value reports which does not require the user to have internet access and which provides information to the user in a format which is easily displayed on a mobile device.

### Verbal Reporting

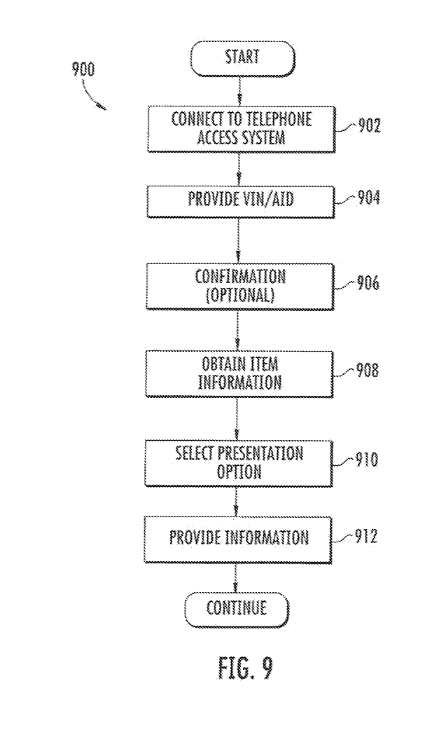

It is further appreciated that the aforementioned systems and methods may be implemented in verbal form, as illustrated in FIG. 9. As illustrated, per step 902, a user connects to a telephone access system. The telephone access system may comprise an automated system accessed by the user dialing a telephone extension (such as a toll-free, 800, or 866 number). At step 904, the user is then connected with a first menu where the user may speak, or dial a VIN (or shortened VIN) or AID. The VIN or AID is optionally confirmed at step 906, such as by a mechanism for verbally repeating the VIN or AID back to the user so that the user may confirm (such as by pressing a key to indicate correctness). Where the repeated VIN or AID is not correct, the user may be given an option to indicate it is incorrect and re-enter it (either by speaking or dialing). The confirmation step 906 reduces erroneous reporting.

Per step 908 of the method 900, the entered (and optionally confirmed) VIN or AID is then used to obtain information regarding the item. In one embodiment, the methods disclosed above, e.g., utilizing the IIC server 100, are implemented at this step. Other methods for obtaining information regarding an item may also be utilized as well.

The user, at step 910, selects from among one or more options for the presentation of the item information. For example, the user may select to have the information presented verbally (such as via a computer automated speech synthesis system), or presented in email, text/SMS message or other message form. This selection may also be pre-stored; e.g., the user may configure his/her account such that it always defaults to text delivery unless told otherwise.

At step 912, the information is presented to the user via the selected mode.

### Client Interface/Account Generation and Management

In one embodiment, the features and options discussed above may only be accessible to clients who have registered and generated an account with the IIC server 100. Registration and account generation may be coordinated through one or more Internet-based interfaces. Thus, a client may be able to set-up an account with the IIC server 100 via an Internet connection and a device capable of accessing the Internet (such as a PC, laptop computer, PDA, or other client device).

In order to establish an account (register or set-up), the client will navigate any standard internet browser in order to access a website tied to the IIC server 100. The website will have at least one tool for demonstrating the capabilities of the IIC system as well as one tool for enabling clients to “sign up” for IIC system services.

It is appreciated that a quick description of product and advertising slogans may be displayed on one or more pages of the website. One or more pages of the website may advertise a dedication to quality, and the general purpose of the IIC system. The IIC system partners (such as item information server 120 owners) may also be displayed to clients and potential clients. For example, the website may indicate a partnership with such companies and services as, inter alia, Auto Check, CarFax (for providing vehicle history reports), and Manheim (for providing wholesale pricing information).

Information regarding membership fees, service fees, and subscription levels may also be presented to clients via the web interface. A linked email address and/or questions/comments page may also be presented.

The website will present the client with a policy and licensing agreement for use of the protected methods and apparatus of the IIC system with an option for the client to accept the terms thereof.

Actual registration (set-up) of an account comprises providing the IIC server 100 with a name, a phone number associated with the client's client device (for accessing and utilizing the IIC system) via the web-based interface. In one embodiment, once the client has entered the above information, the client may test functioning of the system by indicating a desire to receive a test message from the IIC server 100. After the system has been optionally tested, the client provides payment information (including credit card account number, bank information, check card information, check routing number and account, and/or debit card information). The client will be given options to select from subscription plans and/or billing options (such as monthly, weekly, per request, etc.).

Once the payment and other information is received by the IIC server 100, the client will be associated to an account number and added to a client database associated with the IIC server 100.

The client will then establish an account password and log-in ID so as to be able to review and edit his account options at the web-based interface (e.g., change payment information, change status of the account, change a subscription level, change a telephone number, and/or change the current password or login ID associated with the client's account, etc.), pay bills, view upcoming auctions, receive email messages, etc. It is appreciated that in the event a client is unable to enter a proper login ID and/or pass word, temporary and/or then-existing passwords and/or ID will be sent to the client device associated with the account via SMS message.

### Preferences and Searching

In another embodiment, the client may be provided with options for searching a database of automobiles (or other auctioned items) at the web interface. A user is given access to multiple auctions listed by location and/or date. The user can then search the auction(s) of interest for items having particular features or options that the user is interested in. For example, a particular user may be interested in purchasing a BMW at an automobile auction. The user enters features of the BMW such as year, model, color, mileage, etc. into a search engine. The search engine then returns a list of all of the vehicles at the designated auction(s) which match the user's criteria. The search engine is, in one embodiment, adapted to search the auctioned items according to any of the aforementioned criteria as well as others not specifically listed yet germane to the auctioned items themselves. In one embodiment, the search engine may comprise a search engine run from an auction servicer website such as Manheim, etc.

It is also appreciated that a user may create a personalized list of auctioned items. In other words, the user may select one or more automobiles (or other auctioned items) to receive notifications, alerts, or other messages about; the automobiles may be selected from, e.g. the results of the aforementioned search and/or may be manually entered. In one embodiment, the personalized list may comprise a list similar to the Watch List product offered by Manheim. The user may be given an option to have the personalized list forwarded via email, SMS text message, voice message or otherwise to the user's client device prior to the date and time the auction is to take place. As noted previously, the user's client device may comprise any mobile electronic device capable of receiving SMS or other data/text messages, email messages or voice messages, such as e.g., a 3G smartphone with broadband capability, such as the ubiquitous Apple iPhone.

Information used in creating the personalized list, as well as the list itself, are held confidentially and securely, such as by utilizing an Secure Sockets Layer (SSL) or Transport Security Layer (TSL) tunnel to transmit data.

### Tracking Server

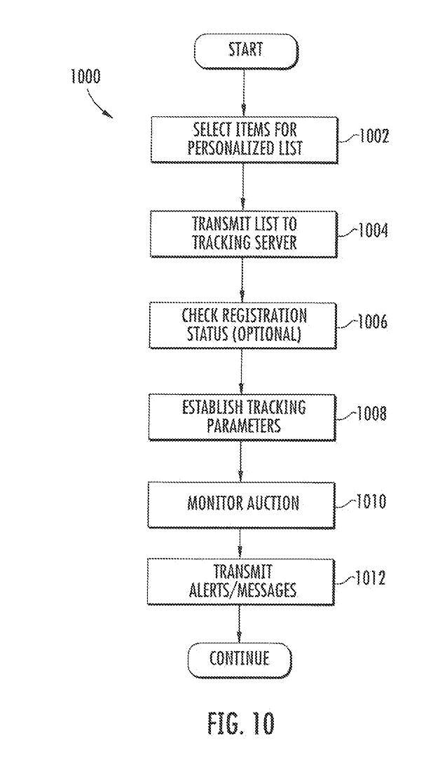

In yet another embodiment, a tracking server is utilized. In one variant, the tracking server tracks the status of each of the items in the auction according to the method 1000 illustrated in FIG. 10. As shown, at step 1002, items are selected by a user for a personalized list. The items are selected for example as described above. The personalized list may be similar to the Watch List product disclosed above as well.

The list is then transmitted or linked to the tracking server (step 1004). The link between the personalized list and tracking system may be established via any number of methods. For example, information regarding each user's personalized list may be securely or non-securely transmitted from a first web server to a tracking server every pre-determined interval of time (e.g., every 2 minutes, etc.). In another embodiment, personalized lists, as soon as created, are forwarded to a tracking server. Other procedures may be used as well.

Per step 1006, the lists are optionally examined to determine whether the user associated with the list has also enrolled or registered for the tracking system. If the user has not registered, they will be given an opportunity to do so.

Next, at step 1008, the user establishes the aspects of tracking. For example, the user may establish that server should send an alert to the user's device (either via SMS text, voice, data, or email message) when a tracked item is a pre-determined number of minutes or vehicles away from beginning auction, when the auction on the item has begun, when the auction on the time has ended, etc.

Per step 1010, the tracking server monitors the auction. The tracking server may be updated via methods which implement current technologies for managing status of the items in an auction. For example, the Internet-based Manheim Simulcast 3.0 system may be utilized in conjunction with the aforementioned tracking system to provide the tracking server with updated status information with respect to tracked items. In one embodiment, the tracking server establishes individual sessions directed at each lane of an automobile auction that is currently running.

In another embodiment, the tracking server may be fed data regarding an entire auction simultaneously.

In yet another embodiment, the tracking server may be integrated with an on-site auction management entity. For example, the tracking server may establish a connection with lane management and/or on-site auction management computers in an automobile auction. The tracking server uses the information gained from the auction management entities to estimate a time when auction will begin on each item.

The tracking server uses the updated auction information to, at step 1012 determine which users to alert (such as by sending text or other messages to the user) regarding items which the user has elected to track. For example, the user may wish to be informed when an auction for a particular item is set to begin within five minutes. The information received from the various management entities is compared to a plurality of individual personalized lists to determine such timing, which is forwarded to the client in the form of alerts, etc. (such as via text message, voice message, email, etc.). Other status information about the items in a user's list may also be forwarded to the user's client device.

In a further variant, a user may communicate with the tracking server so as to track an item during, or just prior to the beginning of an auction. In this embodiment, a user may, via a client device send a message to the tracking server indicating an item number (such as a lane number and run number in an automobile auction) to begin tracking. This may be performed e.g., while the user is at the auction and without requiring the item to be listed on a tracking list. In the instance the user has a personalized list, the additional item may be added thereto. It is also appreciated that a user may be granted access to the tracking system via a web interface; the interface providing the user a means for entering an auction item number for the item to be tracked.

### Recommendations

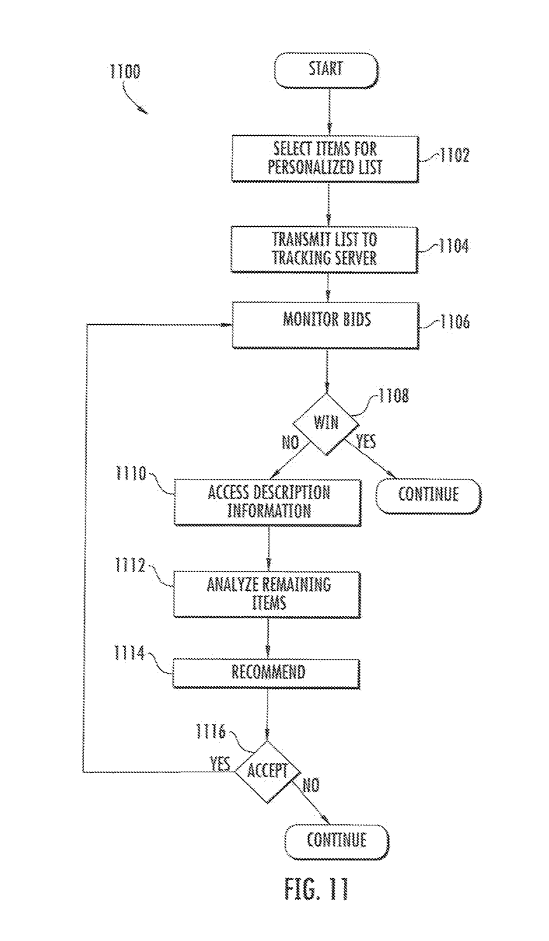

The tracking server may further be utilized to recommend items to a user based on previously bid on items as illustrated in the method 1100 of FIG. 11. As illustrated, per steps 1102 and 1104, a user creates a personalized list of items which is transmitted to the tracking server. It is appreciated that the personalized list may be generated by e.g., the searching methods disclosed above. It is further appreciated that the personalized list may comprise a Watch List as utilized by Manheim. The transmission of the personalized lists to the tracking server may be accomplished via any one of the methods disclosed above.

Per step 1106, the tracking server monitors the bids in an auction. In other words, the tracking server is configured to receive and analyze information regarding the “winner” of each auctioned item. For each auctioned item, the tracking server determines which bidder has entered the winning bid, the tracking server then compares this information to every user which has opted to track the auctioned item (step 1108).

If the user has not won the bid on a particular item, at step 1110, the tracking server accesses information describing the item. At step 1112, the descriptive information is utilized by a recommendation entity for comparison to remaining items. In one embodiment, the recommendation entity comprises a computer program adapted to extract data regarding a first auction item and utilize the data to discover and report (i.e., recommend) to the user other similar items at the same auction (step 1114). The recommendation entity may recommend alternative items, for example, each time a user adds an item to a personalized list. In other words, the recommendation entity receives a message that User A has added a 2007 Black Toyota Camry to his personalized list. The recommendation entity extracts information from the message regarding the User A, such as the users contact information, historical auction data, etc. The recommendation entity also extracts information from the message regarding the auctioned item. The information about the auctioned item is compared to a database of items for auction in order to find additional auction items which are substantially similar to one or more aspects of the selected item. In one embodiment, the search engine may be of the type previously discussed herein. In the given example, the recommendation entity may search for other 2007 vehicles, other Toyota Camrys, etc. The recommendation may use any combination of the features of the selected item to search for similar items.

The user is presented with recommendations (step 1114) and if the user selects one of these options, the tracking server beings monitoring bids with respect to this item (step 1106), such as via the methods disclosed above (establishing a connection to one or more auction management entities or computers).

In another embodiment, the recommendation entity may use one or more factors for broadening a search for auction items similar to a selected item. For example, the recommendation entity may “pad out” the model year of a vehicle to search for similar cars which may be older or newer than the selected car. The recommendation entity may further classify the item such as classifying the Toyota Camry as a 4-door or mid-sized sedan, etc. Various classification and padding schemes may be utilized consistent with the present disclosure.

The recommendation entity may also be adapted to utilize a set of parameters or preferences entered by a user. In a similar manner as that discussed above with respect to searching, a user may enter one or more criteria for recommendations. The recommendation parameters may be broader than specific options or features. For example, a user may be prompted to enter a model year range, or select more than one of a plurality of options (such as different models, manufacturers, or colors), or select from a category of vehicle types (such as SUV, sedan, sports, etc.).

Recommendations may alternatively be presented to a user when the tracking entity informs the recommendation entity that a particular user has won or lost an auction on a selected item. Another Toyota Camry up for auction may be recommended to the winner of an auction for the 2007 Black Toyota Camry. Similarly, other 2007 4-door sedans may be recommended to the user(s) tracking the 2007 Black Toyota Camry who did not win the auction.

The recommended items may be presented to a user in a ranked order, such as by closest match or next available for auction. This may be done by utilizing information gained from the VIN to view the full options associated with the vehicle and comparing this information to the options available for other vehicles. In addition, a vehicle's condition may be accessed by examination of e.g., a condition report (such as that available via Manheim) which contains a full options list a full set of information about scratches and damage to the vehicle as well as estimated repair times and repair costs. It is further appreciated that a user may elect not to view recommended items and/or dismiss recommendations easily such as from the client device. The user may also establish settings for the recommendation of alternatives, including limiting the number of recommended vehicles (i.e. 10 per auction/day) to be forward by at a preferences portion of the web interface.

### Selling/Trading-In an Item

In another embodiment, the aforementioned systems and methods may be adapted to enable a potential buyer to assess the value of an item for sale. For example, a user (whether an individual or an automobile dealership) may utilize the system described above to make a trade-in or purchase offer on an automobile. According to this embodiment, the user (buyer) enters the VIN (or shortened VIN) to obtain information regarding a seller's car. As noted above, the information may comprise a vehicle history report, estimated value report, market report, etc. From this information, the user (buyer) may make an estimate as to the value of the car. Sending the information to a client device may enable the buyer to make an offer “on the spot”.

It is further appreciated that certain additional information may be required in order to more closely approximate the value of an automobile. For instance, the user (buyer) may be prompted to enter the general condition of the car, mileage, and optional features (such as power windows, power locks, leather interior, after market upgrades, etc.). Alternatively, some of this information may be gained from e.g., the VIN and/or condition reports. Then, upon entry of these additional details, the estimated value of the vehicle may be adjusted by e.g., a processing entity in communication with the aforementioned reporting entities. The processing entity having access to the established costs associated with individual damages that insurance companies have developed as well as to costs and values for specific option packages and mileage depreciation is readily available (such as via e.g., Edmunds). By utilizing these rough estimations much similar to the condition reports the processing entity estimates the actual vehicle value.

### Monitoring System

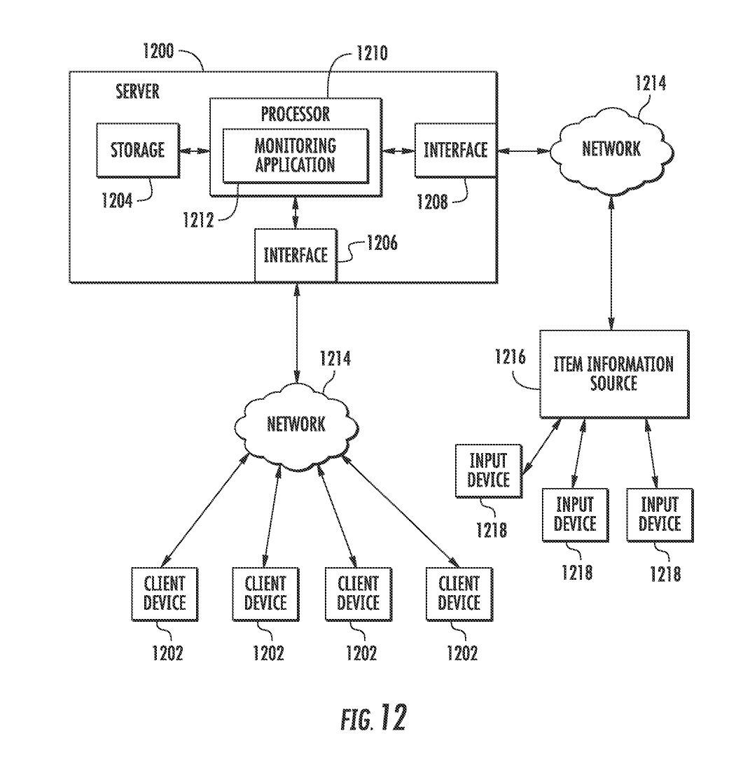

In one embodiment of the present disclosure, one or more monitoring servers are utilized to provide updated item information. An exemplary monitoring server 1200 is illustrated in FIG. 12. As shown, the monitoring server 1200 generally comprises a plurality of interfaces 1206 and 1208 for connection to client devices 1202 and an item information source 1216 via one or more networks 1214. In another embodiment, the monitoring server may comprise a single interface for communication thereto.

Referring back to FIG. 12, the monitoring server 1200 further comprises a digital processor 1210 and an associated storage device 1204. In the illustrated embodiment, the processor 1210 is configured to run at least one monitoring application 1212 thereon. The monitoring application 1212 comprises at least a compare module (not shown), a query module (not shown), and a delivery module (not shown); although other software/logic architectures may readily be substituted.

A first interface 1206 of the monitoring server 1200 functions as a subsystem for the transfer of data into and out of the monitoring server 1200. For example, data in the form of a request may be transferred into the monitoring server 1200 from client devices 1202 via the network 1214; and item information may be transferred out of the monitoring server 1200 to the associated client devices 1202 via the network 1214 via the interface 1206.

The storage device 1204 of the monitoring server 1200 is adapted to store a plurality of lists with each list being associated to a user and/or a user profile in one embodiment. The list, in one variant, comprises at least one vehicle identification number (VIN). In another embodiment, the list may comprise multiple VINs or a bulk number of VINs. In addition, the storage device 1204 is further adapted to store processed and formatted item information or vehicle history reports as discussed elsewhere herein. In one embodiment, the items may comprise vehicles and the processed and formatted item information may be stored or sorted by vehicle VIN number (see e.g., the VIN embodiment discussed with respect to FIG. 2). In another embodiment, items are referenced by auction identification number (AID), which is discussed in greater detail above (see e.g., the AID embodiment discussed with respect to FIG. 3), the AID may be cross-referenced to VINs in vehicle auctions.

As illustrated, the monitoring server 1200 further comprises a digital processor 1210, which, in one embodiment, houses computer programs configured to cause the monitoring server 1200 to generate requests to one or more item information sources 1216, periodically query the item information sources 1216, via in one embodiment the query module, receive push notifications from the item information sources 1216, as well as compare and format data received from the item information sources 1216 into data which is more efficiently transmitted and more easily read by the client devices 1202. In one embodiment, upon receiving updated vehicle information from the item information source 1216, the compare module compares the VINs from the received information to the lists stored in the storage device 1204. The compare module enables the server to determine based on this comparison which users are to be notified that there has been a change in the item information for that particular VIN. In another embodiment, the digital processor 1210 can perform other functions as discussed in detail elsewhere in the disclosure. It is appreciated that the monitoring server 1200 and components related thereto may comprise a separate entity than the vehicle history servers discussed elsewhere herein, or in another alternative may comprise a component or functionality thereof.

In one embodiment, exemplary item information source 1216 includes, inter alia, estimated resale servers, estimated wholesale servers, AID database, auction servicer servers, vehicle history servers, Department of Motor Vehicles (DMV) servers, etc. In yet another embodiment, the information source 1216 comprises a National Motor Vehicle Title Information System (NMVTIS) managed server. The foregoing entities are utilized to obtain information relating to dealership vehicle inventory, vehicles at auction, and/or leased vehicles, company vehicles, rental cars, etc. Formatting may, in one embodiment, comprise summarizing and/or presenting only portions of the data received so as to generate a message which is most germane or suitable (i.e., simple or small enough) for transmission to a client via text message, email, phone call or other messaging in a timely and reliable manner. In another embodiment, the item information source 1216 obtains information relating to the vehicles in real time as it is input via one or more input devices 1218.

The input devices 1218 in one embodiment comprise DMV servers. When information has been received by the DMV server, the DMV server pushes the information to the item information source 1216. In this embodiment the transfer of information between the input device 1218 and the item information source is in real time (or near real time), therefore further enabling updates to be passed to the server 1200 in real time (or near real time). In another embodiment, the input devices 1218 comprise a person entering information into a computer, which is then transmitted to the item information source 1216 in real time. In both embodiments, the information contained at the item information source 1216 is the most recent and most accurate.

The networks 1214 by which the present entities communicate typically comprise unmanaged networks such as internets (e.g., the Internet), but may also be a managed network, or a telephone communication system, such as a telephone line.

The monitoring server 1200 can also be masked or controlled by a “business rules engine” or other logical wrapper or layer as described elsewhere herein.

### Item Information Collection and Monitoring Using Vehicle Identification Number (VIN)

In one embodiment of the present disclosure, the monitoring server 1200 services customers and/or vehicle dealerships who may obtain information and periodic updated information regarding the status of one or more vehicles. In another embodiment, customers may obtain information regarding vehicles at auction or in private sales. The vehicles are thus associated with unique VIN numbers which are input from a user in order to return vehicle information, as illustrated in FIG. 12.

As shown, in FIG. 12, the client devices 1202 transmit a request containing at least one VIN to the monitoring server 1200, via the network 1214. In one variant, the number of VINs contained in the request can be a bulk amount totaling into the thousands or millions. At the monitoring server 1200, the VIN numbers are used in a request message which is sent to any number of item information sources 1216. In one exemplary embodiment, the monitoring server 1200 requests information from an NMVTIS managed server. In another embodiment, the monitoring server 1200 may request information from servers such as an estimated resale server, an estimated wholesale server, a vehicle history server and/or an auction servicer server; however alternate servers adapted to transmit information regarding used items may also be used consistent with the present disclosure. In one embodiment, consistent with the previously disclosed systems and methods, the item information source 1216 upon receiving the request message from the monitoring server 1200 compiles and transmits for each VIN number a vehicle history report (VHR) to the monitoring server 1200. The VHR includes information such as, inter alia, title transfers, title brand events, registrations, odometer readings, thefts, liens, accidents, total loss events, salvage and junk events, towing events, impound events, value changes, etc. The monitoring server 1200 upon receipt of the VHR formats the VHR to a suitable format for the client devices 1202. The appropriate format may be in the form of a text message, an email, an email with an attachment containing the VHR or a telephone call. The monitoring server 1200 then transmits the VHR to the client devices 1202 via the network 1214. Alternatively, the present monitoring service may, rather than providing the VHR, simply provide updates as discussed below.

In one embodiment, the monitoring server 1200 queries the item information source 1216 periodically for any updates regarding previous requests made by the monitoring server 1200. The periodic requests are based on e.g., a subscription plan that a user has signed up for and is described in further detail below. The periodic requests can comprise of hourly, daily, weekly, bi-weekly, monthly etc. queries. The item information source 1216 upon receiving a query request compiles information for the VIN numbers contained in the query and transmits the information to the monitoring server. The monitoring server 1200 then compares the information received from the item information source 1216 to the information stored in the storage device 1204 and when an update, change, or additional information has been detected the monitoring server 1200 compiles a VHR and transmits the VHR to the client devices 1202.

In another embodiment, the item information source 1216 on periodic basis pushes information to the monitoring server 1200 associated to VIN numbers of previous requests. In this embodiment, the item information source 1216 only pushes information to the monitoring server 1200 when there has been either an update, change, or additional information for those particular VIN numbers of previous requests provided by the input device 1218. In a further embodiment, this may be initiated via a trigger or other flag provided thereto from the server 1200. The monitoring server 1200 upon receipt of this information takes the VIN numbers from the received information and compares it to the lists stored in the storage device 1204. The monitoring system then formats the information into a suitable format and transmits the information to the client devices 1202.

In another embodiment, the client may, rather than inputting the vehicle VIN number, instead use a camera function of the client device 1202 to take a picture of the VIN number, or OCR software and a scanner. The client device 1202 will then utilize the optical character recognition program (such as GOCR, JOCR, etc.) to convert the pictured image to text, the text is then sent to the monitoring server 1200 as discussed above. The VIN may also be represented by one or more bar codes.

It is appreciated that other forms of VIN entry may also be utilized including e.g., speaking or saying the number into a client device capable of recognizing and translating the speech to text. For instance, a speech recognition algorithm may be resident within the program memory of the device, and in conjunction with a microphone, convert received analog signals from a user (e.g., a VIN or AID) into a digital representation thereof, which is then used to populate an appropriate VHR. Such speech recognition algorithms and systems are well known in the art, and accordingly not described further herein. In yet another embodiment, the speech recognition system may be implemented at the monitoring server 1200 or other entity of the herein described invention.

### Monitoring Methodology

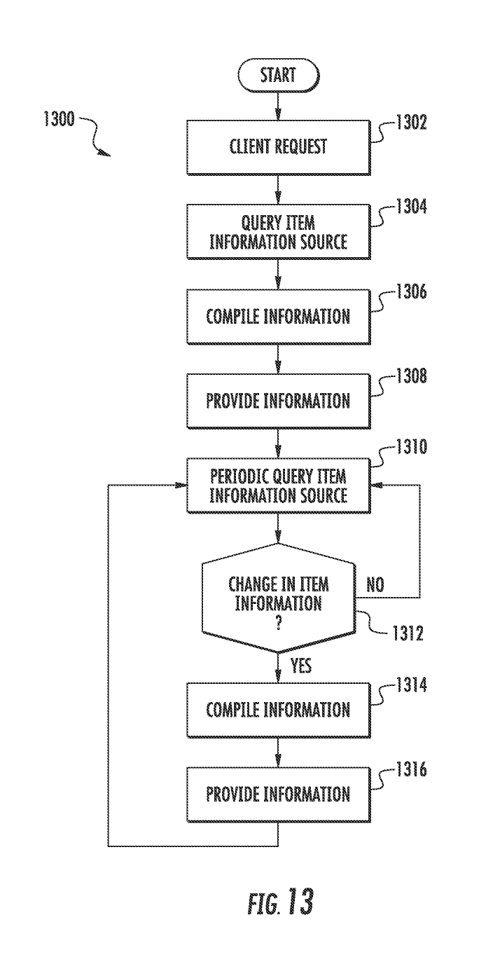

Referring now to FIG. 13, an exemplary method 1300 for utilizing the network architecture discussed above (including that of FIG. 12) to monitor and provide updates to item information is illustrated.

As shown, at step 1302, a user requests information relating to the quality of a plurality of items. The user generates this request by entering a unique identifier associated with each of the plurality of items. For example, in the instance the items comprise vehicles, the user may via a client device 1202 enter the VIN for each vehicle. The present disclosure in one embodiment enables a user to monitor a large volume of items, hence the user may enter the VIN (or other identifier) in bulk such as by (i) taking pictures of the VIN and using OCR to translate the picture into alpha-numeric characters, (ii) manually entering the VIN using a keyboard associated with a personal or laptop computer, tablet, or smart telephone or other device, (iii) uploading the VIN from another computer program or list, and/or (iv) determining a VIN from a scanned or pictured bar code. The client request is transmitted via a network 1214 (such as e.g., the internet or Internet) to a monitoring server 1200. In one embodiment, the monitoring server 1200 is a component of one or more of the previously referenced server apparatus. Alternatively, the monitoring server 1200 comprises a separate entity in communication therewith.

An application running on the monitoring server 1200 uses information within the client request to query an item information source 1216 at step 1304. The information which forms the basis of the request may include the VIN for each of the vehicles about which information is sought. Additionally, the requesting client device 1202 and/or requesting server 1200 may be identified in the request. In one embodiment, the request may include an identifier which corresponds to one or more options for triggering receipt of updates to the information. Alternatively, the request may include a metadata file which identifies each VIN and specifies one or more rules for updates thereto. For example, as will be discussed in further detail below, a user of a client device 1202 may specify a start and stop date/time and/or a periodicity for obtaining updated information related to one or more of the vehicles which information was requested. Alternatively, the server 1200 may establish rules for a periodicity and/or start or stop date/time for receiving updated information based on e.g., a subscription level of the user of the requesting device 1202.

Communication between the server 1200 and the item information source 1216 may occur over an internet or Internet or other communication network.

In response to the query, per step 1306, the item information source 1216 compiles necessary information. In one alternative embodiment, the other herein described item quality information entities 114 are alerted and a history report is generated according to the herein described methods simultaneous to the information generated by the item information source 1216. As discussed above, the item information source 1216 in one variant comprises a centralized database for vehicle information which is updated in real-time based on inputs from various operators around the country. According to this embodiment, information relating to vehicle title brands, etc. is immediately provided to the information source 1216 when it is entered by an operator at an input device 1218 in communication therewith. In this manner, the information source 1216 is provided the most accurate and up-to-date history information. Information from this highly accurate centralized data base will supplement the data obtained from the other described item quality information entities 114. Information from the item information source 1216 per step 1308 is provided to the server 1200.

Alternatively, the method of FIG. 13 may act as a stand alone method wherein only updated vehicle information is provided to the client devices 1202 (rather than delivery of entire vehicle history reports).

Per step 1310, the server 1200 (or another server discussed herein) utilizes all of the information gathered in response to the query of the item information source 1216 (and any other item quality information entities 114) to generate a report which is provided to the requesting client device 1202. In one embodiment, a full report is generated at this time (as discussed above). The server 1200 in this embodiment, uses the highly accurate information obtained from the item information source 1216 to update information obtained from other entities.

As noted previously, the server 1200 further includes a triggering mechanism within its original request to the item information source 1216 which indicates any applicable start/end dates or times for providing updated information as well as a periodicity at which updates will be provided. In one variant, the trigger is managed by the server 1200 such that at the appropriate dates/times (according to the periodicity and start/end dates), the server 1200 actively requests updated information from the item information source 1216 (step 1310). Alternatively, the periodicity and start end date information is transmitted to the item information source 1216 at the time of the initial query (step 1304 above) and utilized to trigger the item information source 1216 to automatically provide updated information relating to one or more of the previously searched vehicles. In other words, the original query or request to the information source 1216 includes a trigger for each searched VIN that the information source 1216 should automatically push any information about that VIN to the server 1200 at a given frequency and for a given duration.

At step 1312, the server evaluates the newly provided item information to determine for each VIN whether any changes have been made to e.g., the title, the description etc. thereof. In the instance no changes have been identified for a particular VIN, the system awaits the next periodic query for that VIN. Information is complied regarding the VIN for which changes were detected (step 1314) and the information provided to the originally requesting client device 1202. The system then awaits further periodic queries on these VIN as well. A significant advantage of the present system is that the information updates occur in real-time (or near real-time).

As noted previously, in one embodiment, a particular VIN may be searched by multiple client device 1202, in this instance the server 1200 may further, prior to querying the item information source 1216 determine whether information for that particular VIN is already stored in storage 1204. If there is no previous information, the VIN is queried; if there is previous information the server may simply rely on the information in storage for delivery to the all devices requesting that data.

In a further embodiment, alerts regarding updated vehicle information may be directly provided between the information source 1216 and the client devices 1202 (not shown). According to this embodiment, there is a decreased lag time in providing the data to the end user (as may be experienced in the event the server 1200 pre-processes the data before transmitting it to the end user.

As noted above, the foregoing methods enable a client or end user to submit a high volume of VIN numbers to the server 1200 (such as thousands or even millions). An API with which a user interfaces is configured to accept the VIN in character separated values (CSV) plain text, text from OCR data, or other similar format. In one exemplary embodiment, the VIN are passed to an item information source 1216 such as one managed by e.g., NMVTIS. The information source 1216 monitors the requested VIN numbers periodically, including e.g., a daily query. The information source 1216 may be configured to identify changes in title and registration events. According to this example, when a change or submission of change title status is made (such as through the NMVITS system) an alert is forwarded to the server 1200. Alternatively, the information source may simply pass all information to the server 1200 for processing thereat and a determination of whether any changes have been made to the given VIN. The server 1200 or information source 1216 identifies these changes such as by comparing newly acquired real-time data to previously stored data for that same VIN.

In one variant, the information contains the following;
VIN verification
Make, Model, Year
Date of title filing
State of title submission and registration
Odometer reading at time of filing (excluding state exemptions for such)
Title brand status
JSI (junk, salvage, and insurance total loss)status
   The following example illustrates the aforementioned methodology in one embodiment:
The following VIN has had a change of title status:
A Title and registration update has been filed with the state as indicated below.
VIN Number 12345678901234567 Customer Number: 12345
Chevrolet
Impala
2009
Date: 6/23/13 State: California Title and Registration Odometer 23,425 miles
A Title Brand event has been applied to the title of this vehicle
Brand: Salvage date: xx/xx/xxxx state: Texas

Exemplary VIN queries may be provided to the information source 1216 (and associated order data) as follows:
VIN number
Customer Number (for Tracking)
Start date
Close date (3 variations)
   1. A specified end date to queries
   2. Query ends when the first title change alert is generated and VIN is removed from system
   3. Open ended. The VIN remains in the system and multiple alerts are generated until requested to be removed
      © Copyright 2014-2015 KAR Auction Services, Inc. All rights reserved.

### Example Operation

In one specific embodiment, the foregoing apparatus and methods are utilized to monitor one or more VINs with automatic ongoing updates based on real-time data associated to the National Motor Vehicle Title Information System (NMVTIS). According to this embodiment, the herein referenced IIC server 100 sends a request to a server at NMVTIS. The request comprises a request for data relating to the one or more VIN. In one variant, the request may utilize e.g., a “ping and post” system. The IIC server 100 utilizes the data obtained from NMVTIS to generate a first report for each VIN; the reports include e.g., NMVTIS Title, insurance total loss and salvage data.

The first reports themselves are each associated to individual ones of data inquiries, such as by VIN number either by the ICC server 100 or other entity associated therewith and/or in communication therewith. NMVTIS may then periodically, such as via recurring automatic alert or message from the ICC server 100, scan its real-time database to look for records which have a date/time stamp that is newer than that of the first inquiry (as also indicated by a date/time stamp on the first reports). When it is determined that one or more of the VIN have newer records than those utilized for the first report (based on a comparison of the date/time stamp of the report to the date/time stamp of the records), a new report is sent from NMVTIS to the ICC server 100. It is appreciated that the determination may be performed by a processor or other device or other logical process/entity associated with NMVTIS, or by a processor or other device or process associated with the ICC server 100. In the instance the determination is performed by an ICC server-associated entity, the ICC server 100 then triggers the NMVTIS to provide the record in full so that a second (updated) report may be generated. More specifically, the ICC server 100 in one implementation executes logic configured to evaluate the reports (e.g., compare the first report and the second (updated) report to determine which records or aspects of the data contained therein have changed).

An updated record and/or an updated full second report is then transmitted to the original requesting device. In one variant, the updated full report highlights or otherwise emphasizes a change to its data over previously provided records for that VIN.

In another implementation, the data which is obtained comprises data relating to theft and/or security interests or liens on a particular VIN. The above-disclosed methods and apparatus are therefore utilized to generate and store a first report of theft and/or lien data. The sources of theft and/or lien data are periodically queried for updated real-time data (as discussed above). The ICC server 100 uses information from the updated query to determine whether any of the information has changed as compared to information in the stored reports. In one variant, changes are detected by comparing data in particular records to newer data based on a date/time stamp thereof. When changes are detected, the changes themselves and/or updated reports which highlight the changes are provided to the originally requesting client.

An exemplary method may be performed as follows. First, a server (such as server 1200 of FIG. 12 described above) requests information relating to a single item or a batch of items which are identified by e.g., a unique identifier; the requests are sent to an information source. In one example, the items comprise vehicles and they are identified by a VIN and the information source comprises a server associated with the aforementioned NMVTIS system. A response to the request is received in the form of one or more VHR (as discussed above). Additionally, a first run date is marked as a metric by which both the requesting server and the information source may reference in determining whether changes to the data have been made. The initial response to the request (i.e., the one or more VHR) are used as a baseline report or reports to which later information will be compared. The initial report or reports are provided to a requesting client device. In one embodiment, the baseline reports are sent directly to the client without storage at any storage entity associated to the requesting server. After a predetermined amount of time (i.e., periodically such as hourly, daily, weekly, monthly, etc.), the information server re-runs a query of the identified items. When a record appears in the information source system which is associated to a specific item from the initial query and has a date/time stamp which is after that of the baseline data, the information source forwards the entire VHR to the server. Alternatively, only a portion may be provided. The server may then optionally run a script to determine whether the date/time of the records within the newly received VHR are after the date/time of the initially run query. Records which are subsequent to the initial query are sent via push notification to the appropriate client device. In another implementation, the server sends the entire updated VHR to the client device as opposed to only the individual record.

It is further appreciated that after a period of time and/or in combination with the aforementioned periodic queries, the information source may notify the server of records which were or have been deleted. A report of excepted records may be sent e.g., weekly, monthly, etc.

### Client Interface/Account Generation and Management

In one embodiment, the features and options discussed above may only be accessible to clients who have registered and generated an account with the monitoring server 1200. Registration and account generation may be coordinated through one or more Internet-based interfaces. Thus, a client may be able to set-up an account with the monitoring server 1200 via an Internet connection and a device capable of accessing the Internet (such as a PC, laptop computer, PDA, or other client device).

In order to establish an account (register or set-up), the client will navigate any standard internet browser in order to access a website tied to the monitoring server 1200. The website comprises at least one tool for demonstrating the capabilities of the monitoring service as well as one tool for enabling clients to “sign up” for monitoring services.

It is appreciated that a quick description of product and advertising slogans may be displayed on one or more pages of the website. One or more pages of the website may advertise a dedication to quality, and the general purpose of the monitoring services.

Information regarding membership fees, service fees, and subscription levels may also be presented to clients via the web interface. A linked email address and/or questions/comments page may also be presented.

The website will present the client with a policy and licensing agreement for use of the protected methods and apparatus of the monitoring services with an option for the client to accept the terms thereof.

Actual registration (set-up) of an account comprises providing the monitoring server 1200 with a name, a phone number associated with the client's client device (for accessing and utilizing the monitoring service) via the web-based interface. In one embodiment, the client may enter the type of business they are in and the vehicles VINs associated with that business, for example a bulk car buyer or dealer. Another such example is a rental car business. The rental car business may upon registering enter their entire vehicle fleets VINs to be monitored in by the monitoring server 1200. In this example, the rental car business will be notified in real-time or near real-time when an event occurs to one of their vehicles. One such event may be if the vehicle was in an accident. Other such businesses that could monitor in real-time their vehicles include leased vehicles, dealership inventory, taxi companies, trucking business, warranty companies (which monitor whether a warranty is out of service due to title change), original equipment manufacturers or OEM, banks (which monitor change of title to assess outstanding loan amounts), floor plan companies (which provides funding to dealerships for obtaining inventory, as they could via the herein disclosed systems and methods ensure that dealers are not fraudulently using money from selling a first car prior to paying off a loan thereon), insurance companies (to monitor branding or salvage changes when underwriting and/or determining rates), title lean or loan companies (which provide funding for title loans), individual owners/sellers and buyers, etc. In one embodiment, once the client has entered the above information, the client may test functioning of the system by indicating a desire to receive a test message from the monitoring server 1200. After the system has been optionally tested, the client provides payment information (including credit card account number, bank information, check card information, check routing number and account, and/or debit card information). The client will be given options to select from subscription plans and/or billing options (such as monthly, weekly, per request, etc.). The subscription plans can range from querying daily, weekly, biweekly, etc. In addition, the subscription plans can vary in detail, such as, providing information only when there is a change in title to providing full vehicle history report when any portion of the vehicle history report has been changed or updated. In one variant, the client may set up time limits on the periodic updates, such as start on Aug. 1, 2014 till Dec. 1, 2014 or the client can set up the time limit to correspond to an auction event date and/or time. The entry of a start/stop date and/or time may also enable real-time updates such as during an auction as discussed above.

Once the payment and other information is received by the monitoring server 1200, the client will be associated to an account number and added (such as via a MAC or IP address relating thereto) to a client database associated with the monitoring server 1200. In one variant, the client database is stored in the storage device 1204 of the monitoring server 1200. In another embodiment, the client database is stored on another server in communication with the monitoring server 1200

The client will then establish an account password and log-in ID so as to be able to review and edit his account options at the web-based interface (e.g., change payment information, change status of the account, change a subscription level, change a telephone number, and/or change the current password or login ID associated with the client's account, etc.), pay bills, view upcoming auctions, receive email messages, etc. It is appreciated that in the event a client is unable to enter a proper login ID and/or pass word, temporary and/or then-existing passwords and/or ID will be sent to the client device associated with the account via text message, email, or telephone call.

### Business Methods and Considerations

Various exemplary business-related aspects of present disclosure are now described in detail.

In one embodiment, access to the various ones of the above-described features of the IIC system are featured as part of one or more optional subscription plans.

For example, access to increased number of item information servers 120 may be charged at a premium over more basic information servers 120. Thus, a first subscription plan may offer access to only one vehicle history server 208, while another plan may offer access to more than one and/or to more renowned vehicle history servers 208 (charged at a higher premium to the client).

In another example, a client may develop a personalized set of information servers 120 each server addition increasing the rate for the service.

In yet another example, access to the time estimate and/or alarm/reminder feature may be charged at a premium over more basic services.

In another example, a user may be offered different reporting levels at different price ranges. For example, access to a full report (such as one containing all information about a vehicle from every information server) may be offered at a higher premium than access to a partial report (such as one comprising short messages generally summarizing information from one or all of the information servers). Still further, a user may be given an option to receive both a full report and a partial report, the full report being sent to an email inbox and the partial report being sent via SMS text message, voice message, or other shortened form.

It is also appreciated that the aforementioned services may be offered on per item inquired into (such as per automobile). Alternatively, a user may purchase a subscription for access to the services on a per-auction, per-month, and/or per-year basis. In further embodiments, a user may pay per-update for each VIN which is monitored using the monitoring apparatus and methods of FIGS. 12-13.

### Operations/Business Rules Engine

In another aspect of the disclosure, the aforementioned processor 104 running on the IIC server 100 (one or more computer programs located thereon) includes a so-called “rules” engine. These rules may be fully integrated within various entities associated with the present disclosure, or may be controlled via e.g., the client device 202. In effect, the rules engine comprises a supervisory entity which monitors and selectively controls the item information acquisition and delivery functions at a higher level, so as to implement desired operational or business rules. The rules engine can be considered an overlay of sorts to the remote content management and delivery algorithms.

For example, one rule implemented by the rules engine may comprise providing alerts/reminders to certain classes of subscribers or users (e.g., those at a premium level of service, or subscribers who have “opted-in” to receiving the alerts/reminders).

Another rule might comprise providing access to additional information or features such as detailed research, information, access to law enforcement or manufacturers records, etc., for subscribers who sign up for a “premium” plan.

Many other approaches and combinations are envisaged consistent with the disclosure, as will be recognized by those of ordinary skill when provided this disclosure.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims. It will be appreciated that while certain steps and aspects of the various methods and apparatus described herein may be performed by a human being, the disclosed aspects and individual methods and apparatus are generally computerized/computer-implemented.

Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A system configured to provide item information, the system comprising:
an item information source configured to obtain information relating to an item quality for a plurality of purchasable items;
a server entity configured to request and/or receive first information relating to the item quality for the plurality of purchasable items and to request and/or receive second information relating to the item quality for the plurality of purchasable items from the item information source; and
at least one client device in communication with the server entity and configured to request and/or receive the first and/or the second information;
wherein the server entity is further configured to compare the first and second information to identify any differences therebetween, and deliver information relating to the identified differences to the at least one client device.

2. The system of claim 1, wherein the information relating to the item quality for the plurality of purchasable items comprises vehicle history information for a plurality of vehicles.

3. The system of claim 1, wherein the information source comprises a server associated with the National Motor Vehicle Title Information System (NMVTIS).

4. The system of claim 1, wherein the first information comprises a plurality of data fields, and the second information comprises an update to one or more of the plurality of data fields of the first information.

5. The system of claim 4, wherein the request for the second information occurs periodically after the request for the first information.

6. The system of claim 1, wherein the client device is charged consideration for receipt of the information relating to the identified differences.

7. The system of claim 1, wherein the at least one client device further comprises at least a client interface configured to enable a user thereof to establish an account with the server entity.

8. The system of claim 7, wherein, the account is configured to enable the user to identify individual ones of the plurality of purchasable items about which the user is interested in receiving information.

9. A method for providing information regarding a plurality of items for sale, the method comprising:
receiving a request for information regarding a plurality of items;
querying an item information source to obtain the requested information;
providing the requested information;
based at least in part on the request, causing, at predetermined future times, respective ones of a second query of the item information source are performed, the second query resulting in second information regarding particular ones of the plurality of items; and
delivering the second information.

10. The method of claim 9, wherein the second information comprises a subset of information configured to update one or more aspects of the requested information.

11. The method of claim 9, wherein the plurality of items comprise a plurality of vehicles, and the request for information includes a plurality of vehicle identification numbers uniquely associated to respective ones of the plurality of vehicles.

12. The method of claim 9, wherein the predetermined future time is monitored by a server apparatus configured to, at the predetermined future time, cause the respective second query to be initiated.

13. The method of claim 9, wherein the predetermined future time is monitored by an entity configured to, at the predetermined future time, provide the second information absent any request therefor from another entity.

14. The method of claim 9, wherein a predetermined amount of consideration is required in exchange for one or both of the requested information and the second information, the consideration being required substantially simultaneous to the delivery of the second information.

15. The method of claim 9, wherein the method further comprises automatically identifying differences between the requested information and the second information; and the act of delivering the second information comprises delivering only information relating to the identified differences.

16. A server apparatus configured to provide information regarding a quality of a plurality of items, the server apparatus comprising:
a first interface configured to enable direct or indirect communication with an item information source;
a second interface configured to enable direct or indirect communication with a plurality of client devices;
a processing apparatus in data communication with the first interface and the second interface and configured to execute at least one computer application thereon; and
a storage apparatus in data communication with the processing apparatus and comprising at least one computer application stored thereon,
the at least one computer application comprising a plurality of instructions which are configured to, when executed on the processing apparatus:
(i) receive a request for at least one of vehicle history and/or quality information, relating to one or more vehicles identified via respective one or more vehicle identification numbers (VINs) from a first one of the plurality of client devices;
(ii) query the item information source to obtain the requested vehicle history and/or quality information via the first interface;
(iii) receive the requested vehicle history and/or quality information;
(iv) provide at least a portion of the received requested vehicle history and/or quality information to the first one of the plurality of client devices via the second interface;
(v) receive, at one or more subsequent times, second vehicle history and/or quality information relating to individual ones of the one or more identified vehicles, the second vehicle history and/or quality information comprising information which has been modified by the item information source in at least one respect subsequent to the request; and
(vi) provide the second vehicle history and/or quality information to the first one of the plurality of client devices; and
wherein the server apparatus is further configured to perform said (i) receipt of a request; (ii) query of the item information source; (iii) receipt of the requested vehicle history and/or quality information; (iv) provision of at least a portion of the received requested vehicle history and/or quality information; (v) receipt, at one or more subsequent times, of the second vehicle history and/or quality information; and (vi) provision of the second vehicle history and/or quality information, to at least one other of the plurality of client devices substantially simultaneously with the first one of the plurality; and
wherein the server apparatus if further configured to authenticate the first one and the at least one other of the plurality of client devices comprise devices prior to providing access to the vehicle history and/or quality information.

17. The server of claim 16, wherein the plurality of instructions are further configured to, when executed, identify individual modifications represented in the second vehicle history and/or quality information.

18. The server of claim 16, wherein the plurality of instructions are further configured to, when executed, request at the periodic intervals, the plurality of second vehicle history and/or quality information.

19. The server of claim 16, wherein the information source is configured to provide the second vehicle history and/or quality information in substantially real-time as it is inputted by an operator at an input device in communication with the information source.

20. The server of claim 16, wherein a predetermined amount of consideration is required in exchange for one or both of the requested vehicle history and/or quality information and the second vehicle history and/or quality information.
